(19) United States
(12) Patent Application Publication
(10) Pub. No.: US 2026/0104578 A1
(43) Pub. Date: Apr. 16, 2026

(54) METHOD, TECHNIQUES, AND SYSTEM FOR PROLATE SPHEROID RING ILLUMINATION SYSTEM

(71) Applicant: 4D Licensing Group LLC, Edmonds, WA (US)

(72) Inventors: Nicholas E. Bratt, Edmonds, WA (US); David W. Rush, Sammamish, WA (US)

(73) Assignee: 4D Licensing Group LLC, Edmonds, WA (US)

(21) Appl. No.: 19/353,988

(22) Filed: Oct. 9, 2025

Related U.S. Application Data
(60) Provisional application No. 63/706,852, filed on Oct. 14, 2024.

(51) Int. Cl. G02B 21/10; F21V 7/00; F21V 7/04; F21Y 113/13; F21Y 115/10

(52) U.S. Cl. CPC G02B 21/10; F21V 7/0008; F21V 7/0066; F21V 7/045; F21Y 2113/13; F21Y 2115/10; G02B 2207/123

(57) ABSTRACT

Apparatuses, methods, systems, and techniques are provided for a configurable compact illumination system that provides the efficient optical illumination of objects, samples, or areas for the purpose of observing one or more properties of the illuminated object, sample, or area. Example embodiments provide an example Prolate Spheroid Ring Illumination System (PSRIS) and additional related example embodiments which provide efficient illumination for applications including but not limited to microscopy, optical instrumentation, and point-of-care medical devices.

### CROSS-REFERENCE TO RELATED APPLICATIONS

This application is a continuation of U.S. Provisional Patent Application No. 63/706,852, entitled “METHOD, TECHNIQUES, AND SYSTEM FOR PROLATE SPHEROID RING ILLUMINATION SYSTEM,” filed Oct. 14, 2024, which application is incorporated herein by reference in its entirety.

### TECHNICAL FIELD

The present disclosure relates to methods, techniques, and systems for a compact configurable solid state illumination system that provides the highly efficient optical illumination of objects, samples, or areas, and in particular to methods, techniques, and systems for the illumination of objects, samples, or areas for the purpose of observing one or more properties of the illuminated object, sample, or area.

### BACKGROUND

Microscopes were first invented in the early 1600's, but did not come into widespread usage until 1830 when the first microscopes that corrected for spherical and chromatic aberrations were manufactured. As microscopes started to be manufactured in large numbers, the market for commercial microscope illumination systems was created. As the magnification capabilities of microscopes increased, the amount of light required to illuminate the sample also increased due to the fact that as the magnification of a lens increases, the aperture present in the objective lens decreases resulting in less light entering the eyepiece.

All optical microscopes rely on the collection and analysis of light from an illuminated sample, object, or area (hereafter referred to as the sample) to reveal information about the characteristics of the sample. Being able to properly illuminate the samples being viewed through microscopes is a constantly evolving design challenge that continues to the present day.

The general characteristics of the illumination method used determines what information about the sample can be observed as well as the fidelity of that information. Important characteristics of the illumination may include optical wavelength, irradiance or optical power per unit area, angle of arrival, area of illumination, polarization, optical phase, and duration of illumination. Different microscopy techniques require different types or modes of illumination. Many illumination modes are known—e.g. Kohler, critical, transmitted, reflected, brightfield, darkfield, white light, single color, and UV fluorescence. In some cases, the use of additional light controlling or filtering elements in the imaging path are also required—e.g. phase contrast, polarization, and visible fluorescence.

Because of its importance to the overall operation of the microscope, the illumination system is often built-in or integral to the design of the microscope. When deciding which illumination modes to include in hardware designs, microscope designers consider both the target application space for the microscope as well as the cost and complexity of implementing multiple illumination modes. For example, low-cost microscopes may only include the option for brightfield white light transmission while more expensive microscopes may include the ability to switch between several of the previously described illumination modes. Regardless of the design, these built-in illumination systems are not transferrable from one microscope to another, and due to cost considerations they often lack the particular illumination functionality that may be required when the microscope is actually deployed and used in any particular application. The educational and mass market microscopy segments are particularly poorly served, as the manufacturers need to keep manufacturing costs as low as possible. Therefore microscope illumination functionality often suffers in these markets, or is simply left to third party manufacturers to address.

As technology has evolved, the magnification and illumination of samples has also become important in many areas outside of the traditional field of microscopy. These include but are not limited to the fields of general optical instrumentation, medical optical devices used in evaluation and surgery, point of care systems, photoplethysmography, smartwatches and many other fields that require the illumination and examination of samples and the collection and analysis of their reflected optical emissions.

Given the long history of microscopy, external accessories for illuminating a sample have been on the market for many years. The most commonly known and used examples include gooseneck illuminators and ring illuminators. However, these external illumination devices have numerous disadvantages.

Gooseneck illuminators employ light sources at the ends of one or more flexible arms. By adjusting the flexible arms, the light sources may be positioned at accessible positions above the sample and oriented to direct illumination from the light source towards the sample plane. Gooseneck illuminators are typically not a practical solution for transmitted light illumination modes, because it is difficult to position them below the sample plane. Gooseneck lamps can also create shadows, especially if the light is not positioned optimally. This can be particularly problematic in high magnification microscopy where shadows may interfere with the clarity of the image. Depending on the position and type of bulb used, gooseneck lamps can also produce glare or reflections on the specimen, especially with reflective or transparent samples. Finally, gooseneck illuminators are inconvenient to use because they occupy a significant area of the workspace around the base of a microscope and are difficult to move between microscopes as they need to be set up and positioned again for each microscope.

Ring illuminators employ one or more concentric rings of light sources such as LEDs designed so that the illumination is directed towards an area on a central optical axis above or below the ring of light sources. External ring illuminators are often designed to surround and attach to the microscope's primary light gathering optic and provide reflected light illumination to a sample plane. For many microscopes, ring illuminators are not a viable source for transmitted light illumination modes because it is difficult to position them below the sample plane.

Ring illuminators can be very inconvenient to use because they are often designed to mount directly to the microscope's primary light gathering optic. This is especially inconvenient when using a compound microscope with multiple objectives on a turret. The size of the ring light may also not be compatible with all microscope setups, especially if space around the objective lens is restricted.

A particularly important failing of both gooseneck illuminators and ring illuminators is that they are typically very inefficient because they illuminate a large area around the sample in addition to the sample itself, and the light rays that they generate are not efficiently concentrated to the target area of the sample. Many existing designs try to offset this by adding additional LEDs, which just increases the complexity and cost without addressing the core inefficiency of existing designs.

Finally, for many microscopy applications it is desirable to illuminate a sample with UV light and observe the visible fluorescence. However, exposure of the eye or skin to concentrated UV radiation may be hazardous. Any position in the optical path of the UV light that is accessible to a user creates an opportunity for exposure to harmful levels of UV radiation. Because both gooseneck illuminators and ring illuminators are typically mounted such that there is an accessible optical path, this presents the opportunity for exposure to harmful levels of UV radiation.

### BRIEF DESCRIPTION OF THE DRAWINGS

The patent or application file contains at least one drawing executed in color. Copies of this patent or patent application publication with color drawings will be provided by the Office upon request and payment of any necessary fee.

FIG. 1 is an example rendering of an example Prolate Spheroid Ring Illumination System.

FIG. 2 is an example diagram of various devices in different target markets that can utilize an example Prolate Spheroid Ring Illumination System.

FIG. 3A is a perspective view of an example embodiment of an example Prolate Spheroid Ring Illumination System.

FIG. 3B is an exploded view of an example embodiment of an example Prolate Spheroid Ring Illumination System.

FIG. 4A is a perspective view of one LED-reflector section of an example embodiment of an example Prolate Spheroid Ring Illumination System.

FIG. 4B is an annotated perspective view of one LED-reflector section of an example embodiment of the example Prolate Spheroid Ring Illumination System.

FIGS. 5A-5D illustrate various views of a prolate spheroid surface generated by rotating an ellipse about its major axis and various truncation planes used to design an example embodiment of an example Prolate Spheroid Ring Illumination System.

FIG. 6 is a perspective rendering of an example embodiment of an assembled Prolate Spheroid Ring Illumination System with six LED optical ray paths intersecting at an illumination area.

FIGS. 7A-7B show a side view and a section view of an example embodiment of an example Prolate Spheroid Ring Illumination System.

FIGS. 8A-8C show an example embodiment of the example Prolate Spheroid Ring Illumination System with two optical ray paths traveling from an illumination source to an illumination area using reflective surfaces to cause three folds.

FIGS. 9A-9C show an example embodiment of the example Prolate Spheroid Ring Illumination System with two optical ray paths traveling from an illumination source to an illumination area using reflective surfaces to cause four folds.

FIG. 10 shows a set of mechanical drawings and Zemax rendered ray plots for a frustum reflector assembly.

FIG. 11 shows a set of mechanical drawings and Zemax rendered ray plots for a rotated ellipse reflector assembly.

FIG. 12 shows a set of mechanical drawings and Zemax rendered ray plots for a six segment prolate spheroid reflector assembly of an example Prolate Spheroid Ring Illumination System.

FIGS. 13A-13B show example incident radiance plots with zero uniform ring radiance and ideal uniform ring radiance.

FIGS. 14A-14B shows the comparative incident radiance plots for a LED ring illumination device with a frustum reflector.

FIGS. 15A-15B shows the comparative incident radiance plots for a LED ring device with a rotated ellipse reflector.

FIGS. 16A-16B shows the comparative incident radiance plots for an example embodiment of the example Prolate Spheroid Ring Illumination System.

FIGS. 17A-17B illustrate an example embodiment of an example Prolate Spheroid Ring Illumination System for microscopes in different illumination orientations.

FIG. 18 is an exploded view of several components of an example embodiment of an example Prolate Spheroid Ring Illumination System for microscopes.

FIGS. 19A-19B illustrate several elements of an example housing of an example embodiment of an example Prolate Spheroid Ring Illumination System for microscopes and the planes defined therefrom.

FIGS. 20A-20C show details of an example embodiment of an example Prolate Spheroid Ring Illumination System for microscopes oriented in a reflection illumination mode.

FIG. 21A-21C show details of an example embodiment of an example Prolate Spheroid Ring Illumination System for microscopes oriented in a transmission illumination mode.

FIG. 22 shows an exploded rendered view of an example embodiment of an example Prolate Spheroid Ring Illumination System that includes an optional multifunctional baffle.

FIG. 23A-23C illustrates an exploded view and detail views of an example embodiment of an example Prolate Spheroid Ring Illumination System for microscopes that includes an optional multifunctional baffle.

FIG. 24A-24B illustrate a side view of an optional multifunctional baffle used with an example Prolate Spheroid Ring Illumination System for microscopes and a detail section thereof.

FIG. 25 is an example block diagram of an example point-of-care device incorporating a microscope subsystem that incorporates an example Prolate Spheroid Ring Illumination System.

FIG. 26 is an example flow diagram of logic for an example embodiment of an example point-of-care device that incorporates an example Prolate Spheroid Ring Illumination System.

FIG. 27 is a chart illustrating the optical efficiency of an example Prolate Spheroid Ring Illumination System in comparison to a frustrum reflector and to a rotated ellipse reflector.

FIG. 28 is a chart illustrating the radiance uniformity factor of an example Prolate Spheroid Ring Illumination System in comparison to a frustrum reflector and to a rotated ellipse reflector.

### DETAILED DESCRIPTION

The present disclosure relates to methods, techniques, and systems for a compact configurable solid state illumination system that provides the highly efficient optical illumination of objects, samples, or areas for the purpose of observing one or more properties of the illuminated object, sample, or area. Such observations can be made by collecting and detecting the optical signal that as a result of the illumination system is reflected, transmitted, or otherwise emitted from the object, sample, or area. The collection may include an imaging system, and the detection may be by means of direct detection by a human eye or with a wide variety of electronic imaging sensors which may be augmented with image processing and/or artificial intelligence systems.

Apparatuses, methods, systems, and techniques are provided for a compact configurable illumination system that provides the highly efficient optical illumination of objects, samples, or areas for the purpose of observing one or more properties of those illuminated objects, samples, or areas. Example embodiments provide an example Prolate Spheroid Ring Illumination Systems (PSRISes) and additional example embodiments that provide highly efficient illumination for applications including but not limited to microscopy, optical instrumentation, and point-of-care medical devices. The innovative design of the PSRIS provides a comprehensive set of benefits that are not available in any other commercially available system or found in prior art. Example PSRIS embodiments address many of the aforementioned shortcomings of gooseneck and ring illuminators, as well as offering additional capabilities that are significantly superior to other commercially available illumination solutions and prior art. The PSRIS's flexibility, compact size, and configurability allow it to address both the traditional microscopy market and many other vertical markets in the area of general optical instrumentation.

The following is a list of some of the key benefits achieved by use of a PSRIS for illumination of samples. Details of the structures used to achieve these benefits are described in sections thereafter.

### 1. Oblique Illumination to a Single Illumination Area

One benefit is that the PSRIS concentrates oblique illumination from multiple illumination sources to a single illumination area. The PSRIS accomplishes this by using a ring of illumination sources (e.g., LEDs or exit apertures from optical fibers) and a segmented ring of prolate spheroid reflectors configured to concentrate oblique illumination from multiple illumination sources to an illumination area.

Oblique illumination reveals details about a sample that cannot be seen with co-axial illumination. Also, when the angle of the oblique illumination is outside the range of collection angles of the first optic in an imaging path, a dark field condition is created and only the light that is scattered or emitted from the sample is collected by the imaging system. This creates a bright image of the sample on a dark background as opposed to an image of the sample on a bright background. For fluorescent imaging applications, the dark field condition also reduces the requirements for optical filtering by reducing the amount of excitation illumination that is coupled into the imaging path

Imaging systems also have a finite field of view or area over which they can collect light. Any light from the illuminator that is not concentrated to an illumination area defined by the field of view does not contribute to the image, is wasted, and contributes instead to a loss in efficiency and can generate noise in the image. A loss in efficiency means that the LEDs must be driven harder to achieve a given image brightness which in turn results in reduced operating times for battery powered illuminators and the generation of undesirable heat which can be highly problematic for temperature-sensitive specimens.

2. Oblique Illumination with a Uniform Ring of Incident Radiance

Another benefit is that the PSRIS provides oblique illumination with a substantially uniform ring of incident radiance to an illumination area. The PSRIS accomplishes this by using a ring of surface mount LEDs and a segmented ring of prolate spheroid reflectors configured to provide a substantially uniform ring of angular radiance to an illumination area.

An illuminator that produces a substantially uniform angular ring of incident radiance has several advantages. In the case of ideal uniform angular radiance, the power incident on the illumination area comes from all 360 degrees of azimuthal angles and from a bounded range of elevation angles. This creates the ideal oblique illumination condition of illuminating a sample from all sides and minimizes shadowing. It can also increase image resolution. In addition, an ideal dark-field condition is created by illuminating a sample with a bounded range of elevation angles that are outside the range of acceptance angles of the first optic in the imaging system. In this case, the only light that is collected by the imaging system is light that is scattered, reflected, or emitted from the illuminated sample which results in an image of the object on a low noise dark background as opposed an image of the object on a bright background. High quality dark-field illumination that minimizes the background light is particularly advantageous when collecting weak images from a sample using electronic imaging systems and in fluorescence applications where it is required to reduce the excitation wavelength from reaching the image sensor.

### 3. Safer Operating Conditions for UV Illumination

Another benefit is that the PSRIS provides much safer operating conditions for UV illumination compared to previous approaches. For many microscopy applications it is desirable to illuminate a sample with UV light and observe the visible fluorescence. However, exposure of the eye or skin to concentrated UV radiation may be hazardous. UV light can damage the cornea and lens of the eye, and long-term exposure can lead to cataracts and other eye problems. The safe exposure time depends on the UV wavelength, and the concentration or irradiance of the UV light which is defined as the UV optical power per area of illumination. For the case of an illuminator using UV wavelengths, the hazard level must be considered at all accessible points along the optical path from the UV light source up to and including the illumination area as well as for all accessible points along the optical path after the UV illumination exits the illumination area. In cases when the illuminator is used in conjunction with an imaging system that can collect and direct the UV illumination to the human eye, these levels of UV radiation must also be considered. Several features of the PSRIS reduce the hazards associated with the use of UV light. First, the use of the prolate spheroid reflector to create a short illumination working distance minimizes the optical path where UV light is accessible to a user before the illumination reaches the illumination area. Second, the use of a segmented prolate spheroid ring structure creates a fast-converging beam that is only concentrated near the illumination area and falls off quickly as the illumination diverges after passing through the illumination area. Third, the prolate spheroid reflector structure produces a consistent, predictable, and non-adjustable ring of incident elevation angles. When used with an imaging system to create a dark-field illumination condition, no direct UV illumination is coupled into the imaging system. Fourth, when used, the (optional) multifunctional baffle prevents UV rays from exiting the illuminator through the reflector aperture (e.g., the aperture opposite the illumination area).

### 4. Fast Switching of Illumination Wavelengths and Angles

The PSRIS includes multiple independently controlled illumination sources, each of which can be configured to emit different wavelengths and to illuminate the sample plane from distinct ranges of angles. In many microscopy applications, it is advantageous to acquire a sequence of images under varying illumination wavelengths and angular distributions. These images, each captured under different illumination conditions, can be analyzed independently or combined to extract information that would not be accessible using a single wavelength or single angular range.

To maximize the usefulness of using multiple illumination conditions, it is important to minimize the time required to switch between illumination settings, thereby reducing the risk of sample movement or other changes during acquisition. Conventional systems that rely on mechanical switching of filters or optical components are often too slow or cumbersome for such rapid sequential imaging. The PSRIS design allows for fast, non-mechanical switching between illumination wavelengths and angles through electronic selection and control of the active illumination sources. This enables near-instantaneous changes in illumination conditions, improving both temporal resolution and robustness in dynamic or light-sensitive imaging scenarios.

This capability is particularly valuable in fluorescence microscopy and live-cell imaging, where samples are often dynamic and light-sensitive. Rapid switching between excitation wavelengths enables efficient sequential imaging of multiple fluorophores without introducing motion blur or photobleaching due to prolonged exposure. Similarly, fast control of illumination angles allows for advanced contrast methods such as structured illumination or oblique illumination to be applied in real time, without disturbing delicate live samples or requiring physical adjustment of optical components.

### 5. Packaging and Manufacturability

The PSRIS has a number of features and characteristics that make it uniquely efficient in terms of packaging and manufacturability considerations.

The PSRIS is thin, which enables it to be used in a variety of applications. Microscopes in particular have a very limited vertical space between the objective (or objective lens) and the stage. Creating an external illumination source that concentrates illumination at the appropriate point or area whilst maintaining a thin profile is technically difficult and not available anywhere else in the current marketplace. In other markets, such as the Point-of-Care (POC), photoplethysmography and portable medical device market, compactness is an important attribute as the illumination subsystem must be packaged in a small enclosure to be efficiently transported and used in the field.

The PSRIS is a solid-state solution that involves no moving parts. Many previous solutions require fragile optical lenses to concentrate the illumination to a small area. In the portable medical device and consumer device markets, delicate fixed and rotating lenses must be avoided as they are easily misaligned or destroyed by even relatively light impacts. The PSRIS has no moving parts and is therefore uniquely suitable for portable and ruggedized applications like smartwatches and POC devices.

One important innovation of the PSRIS is that it is designed from the ground up to be able to work in a variety of optical devices including those used in mass market applications. To be available to a wide variety of markets, it generally must be manufacturable at a very low cost. The PSRIS ring reflector can be manufactured out of one solid piece of metal or other stock materials using commonly available CAD software and low cost CAD/CAM milling machines or for example it can be molded in plastic and a reflective coating applied for low cost, high volume applications.

### 1. Configurability

Different versions of the PSRIS can be easily created with different design parameters to accommodate different vertical markets. For instance, the area of illumination concentration (e.g., the focus point) on a slide on a microscope stage is different from the focus point on a users' wrist in a smartwatch designed to measure blood pressure. The PSRIS can be configured to handle either application with changes to a few key manufacturing parameters. Due to this characteristic, the PSRIS is uniquely suited for use with parametric design and manufacturing applications.

### A. Structure and Operation of a Prolate Spheroid Ring Illumination System

The figures below present a comprehensive overview of the general functionality, vertical market application areas, and the detailed design information showing how to construct and utilize various example embodiments of the Prolate Spheroid Ring Illumination System (PSRIS).

Analytical models and the results of benchmarks are presented that quantify the efficiency and incident radiance of the PSRIS approach compared to existing systems and approaches. This analysis contrasts the PSRIS with alternative reflector designs and demonstrates the remarkable efficiency and incident radiance uniformity of the approach used to construct the PSRIS. Thereafter, potential uses of a PSRIS in the Point-of-Care (POC) market are described.

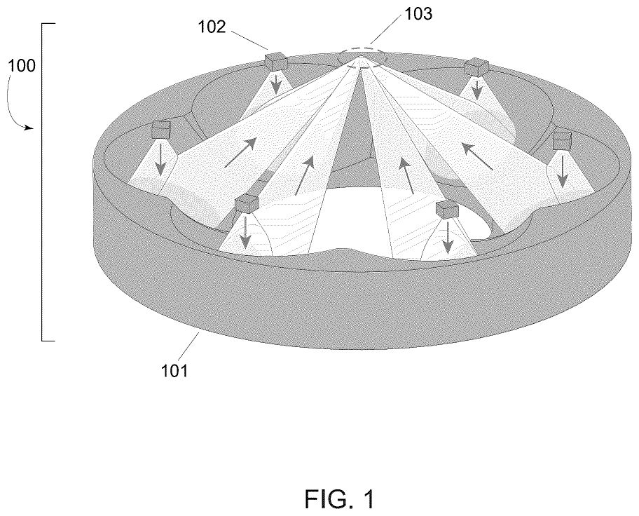

FIG. 1 is an example rendering of an example Prolate Spheroid Ring Illumination System. An example Prolate Spheroid Ring Illumination System (PSRIS) 100 comprises a segmented ring reflector 101 and various light (or illumination) sources 102. In FIG. 1, the segmented ring reflector 101 reflects the light rays emitted by the light sources 102, which in this example embodiment are light emitting diodes 102, and concentrates them on the illumination area 103. In other embodiments the light sources 102 may be the exit apertures of optical fibers, or other small area light sources.

The techniques described herein pertaining to a PSRIS are generally applicable to an illumination source. The example embodiments of the PSRIS assembly described herein frequently refer to use of LEDs as light sources or illumination sources. Those skilled in the art will understand that, in other example embodiments and usage scenarios, different light sources may be incorporated into a PSRIS, such as incorporation of light from optical fiber sources and any needed structure for the support of same. Accordingly, in such embodiments, adjustments to the example embodiment designs for LEDs detailed in the sections below can be made to accommodate optical fiber sources as illumination sources instead of LEDs (for example, by replacing the circuit board with optical fiber mounting equivalents).

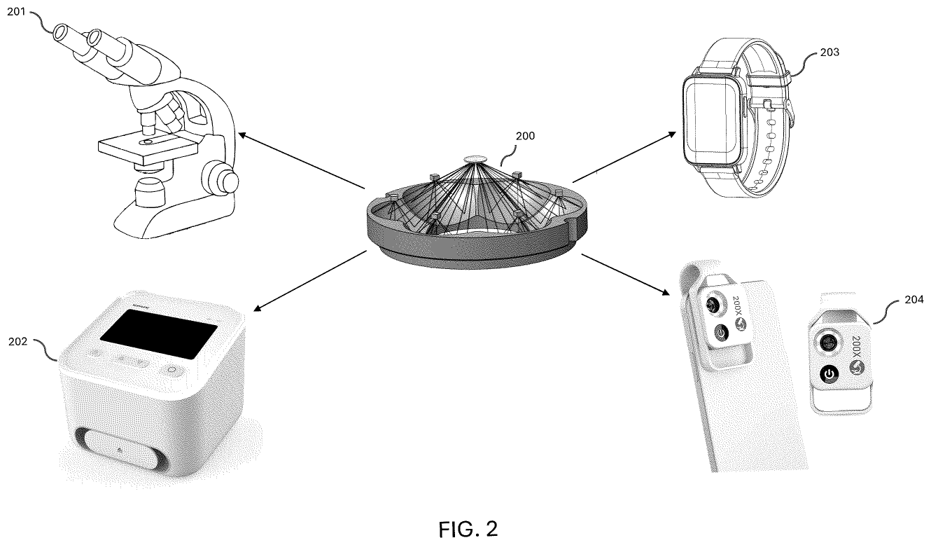

FIG. 2 is an example diagram of various devices in different target markets that can utilize an example Prolate Spheroid Ring Illumination System. For example, the PSRIS 200 can be used in microscopes 201, point-of-care devices like portable blood analyzers 202, wearables that include optical sensing devices such as smartwatches 203 and clip-on microscopes for mobile phones 204.

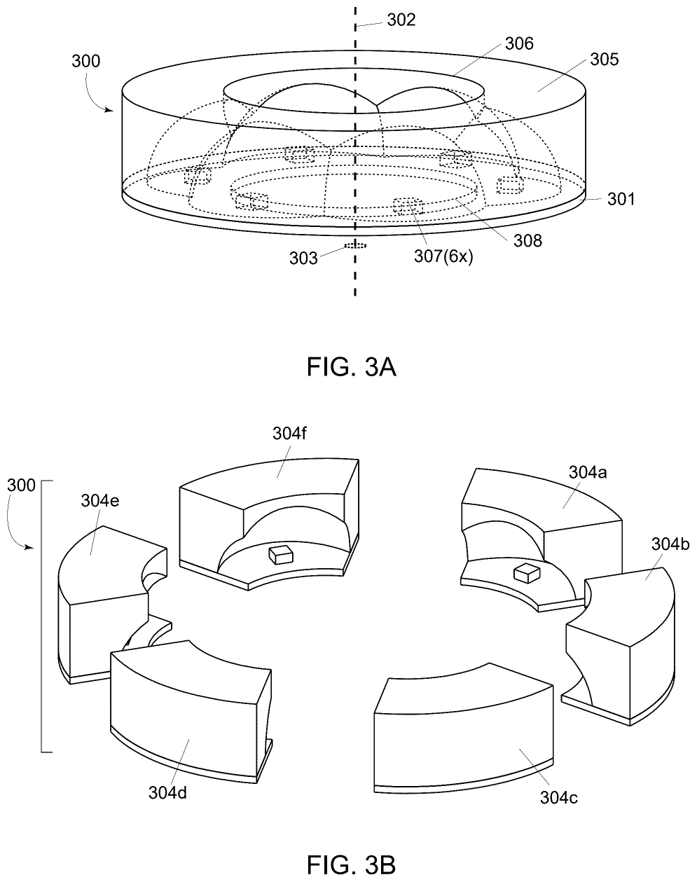

FIG. 3A is a perspective view of an example embodiment of an example Prolate Spheroid Ring Illumination System. FIG. 3A shows a perspective view of a PSRIS 300, a central axis 302, and an illumination area 303. The PSRIS (or PSRIS assembly) 300 comprises a segmented ring reflector 305, a circuit board first section 301, and six LEDs 307. In other examples, such as those using optical fiber sources as illumination sources, the circuit board first section 301 and six LEDs 307 are eliminated and/or substituted. The PSRIS 300 is configured such that the light emitted from any one of the six LEDs 307 reflects from one segment of the reflector 305 and is concentrated to an illumination area 303 below the circuit board first section 301. The assembly central axis 302 passes through the center of a reflector central aperture 306, the center of a circuit board central aperture 308, and the center of the illumination area 303. The illumination area 303 is defined to be normal to the assembly central axis 302. A substantial portion of the light that is reflected, scattered, or otherwise emitted from the illumination area 303 passes through the assembly 300 and can be collected by an optical system that is positioned above the assembly 300.

The structure and operation of the PSRIS 300 can be described as six LED-reflector sections with each section operating independently of the others. Each LED-reflector section comprises a 60-degree segment of the ring reflector element 305, a 60-degree segment of the circuit board first section 301, and one of the six LEDs 307. Each LED-reflector section is configured to concentrate rays diverging from each section's LED 307 to each section's illumination area. The six LED-reflector sections are configured in a ring structure such that the illumination areas of all sections are centered at the same illumination area 303 on the central axis 302. The separation into sections is an abstraction used to simplify the description of the structure. In practice, the segmented reflector may be fabricated as a single element, for example by machining and polishing a single piece of metal or for example by molding a single plastic element and depositing a reflective coating to form the reflective surfaces. In other embodiments, the segmented reflector may be fabricated as some number of LED-reflectors (not necessarily six). In some embodiments, the illumination areas of all of the segments need not overlap.

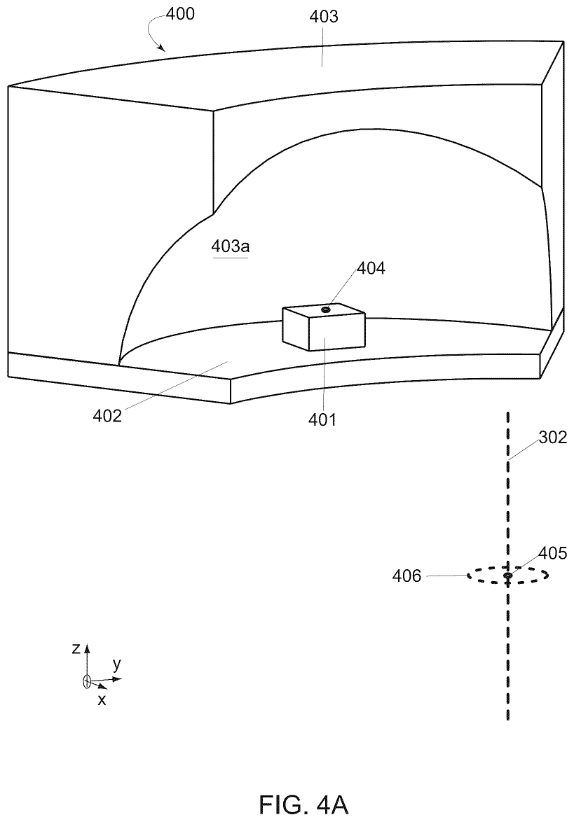

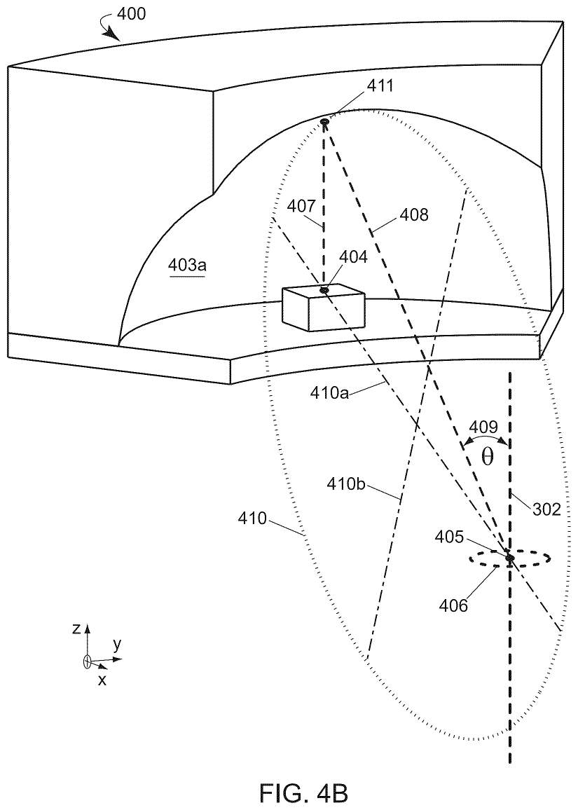

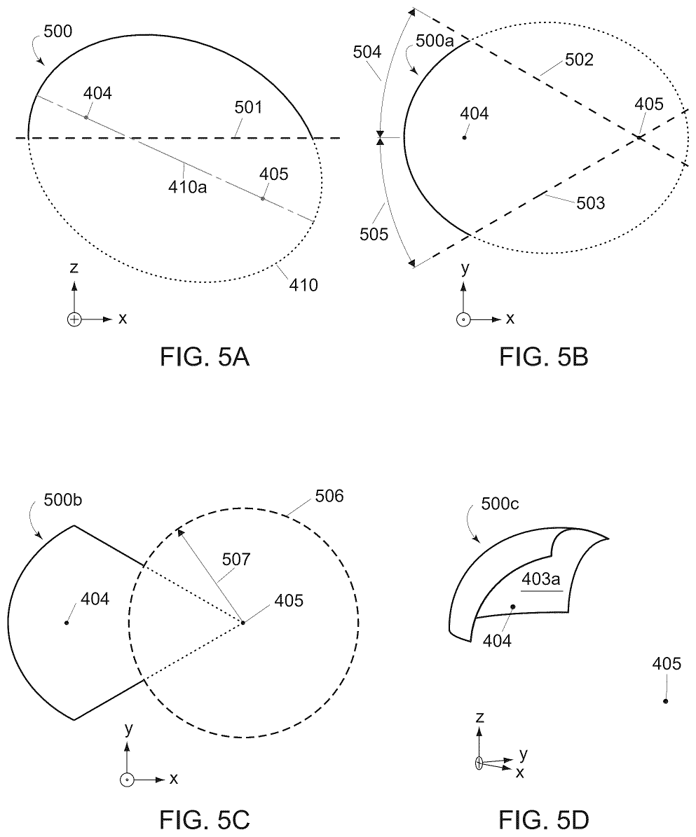

FIG. 3B is an exploded view of an example embodiment of an example Prolate Spheroid Ring Illumination System exploded to view each of the six LED-reflector sections. For example, PSRIS 300 is exploded to view each of the six LED-reflector sections 304a-304f. In the following description, the details, methods, and techniques related to FIGS. 4 and 5 and associated text can be applied to any one or more of the six LED-reflector sections 304a-304f.

### B. Anatomy of a Prolate Spheroid Ring Illumination System LED-Reflector Section

FIG. 4A is a perspective view of one LED-reflector section of an example embodiment of an example Prolate Spheroid Ring Illumination System. FIG. 4A shows one LED-reflector section 400 of the PSRIS 300 shown in FIG. 3B. As assembled, the LED-reflector section 400 includes one LED 401 mounted to a circuit board section 402 and one reflector segment 403 with a reflective surface 403a. The reflective surface 403a has the curvature of a truncated prolate spheroid surface. The LED 401 is centered at a first focus point 404 of the prolate spheroid formed by surface 403a. The resulting LED-reflector section illumination area 406 is centered at a second focus point 405 of the prolate spheroid which lies on the central axis 302 (see FIG. 3A). All rays emitted from LED 401 that are incident on reflective surface 403a are concentrated at the position of the second focus point 405 and provide oblique illumination to the LED-reflector section illumination area 406. The LED-reflector section 400 is oriented in a local x-y-z coordinate system such that both the first focus point 404 and the second focus point 405 lie in the x-z plane and the central axis 302 is perpendicular to the x-y plane.

FIG. 4B is an annotated perspective view of one LED-reflector section of an example embodiment of the example Prolate Spheroid Ring Illumination System. FIG. 4B illustrates the LED-reflector section 400 and a sketch of an ellipse 410 used to generate the corresponding truncated prolate spheroid reflector surface 403a. The ellipse 410 is in the x-z plane. The prolate spheroid is generated by rotating the ellipse 410 about its major axis 410a. The ellipse 410 and the prolate spheroid share the same first focus point 404 and second focus point 405. Also shown in FIG. 4B are the minor axis 410b of the ellipse 410, a LED central ray segment 407, which is a segment of the entire optical ray path from the LED to the illumination area 406, a reflected ray segment 408 of the optical ray path, and the central axis 302. (The optical ray path illustrated comprises both the central ray segment 407 and the reflected ray segment 408.) The LED central ray segment 407 is emitted from the location of the first focus point 404 at an angle phi (not observable) with respect to the central axis 302 and intersects the ellipse 410 at a reflection point 411. The reflected ray segment 408 travels from the reflection point 411 (on the surface 403a) to the second focus point 405 and intersects the central axis 302 at an angle theta 409 (θ).

It will be understood by those skilled in the art that a unique ellipse and it's corresponding unique prolate spheroid are defined by specifying the coordinates of each focus point and the coordinates of any one point on the ellipse. For ellipse 410, the coordinates of the first focus point 404 are given by the location of the LED 401, the coordinates of the second focus point 405 are given by the location of the illumination area 406, and the reflection point 411 is a point on the surface 403a of the ellipse 410. The coordinates of the reflection point 411 are given by the point of intersection between the LED central ray segment 407 and the reflected ray segment 408. It will be further understood by those skilled in the art that the coordinates of the reflection point 411 are readily found given the location of the first focus point 404, the location of the of the second focus point 405, the angle theta 409 between the LED reflected ray segment 408 and the central axis 302, and the angle phi between the LED central ray path 407 and the central axis 302 (not shown). Note that in FIG. 4B the LED central ray segment 407 is drawn parallel to the central axis 302 such that the angle phi is zero, but that the description for specifying the ellipse allows for the case when phi is not zero such that the LED central ray segment 407 is tilted in the x-z plane relative to the central axis 302.

### C. Truncation and Formation of a Prolate Reflector Segment

To build each reflector segment, the extent of the reflector surface 403a as shown in FIGS. 4A and 4B is determined by truncating the prolate spheroid surface that is generated by rotating the ellipse 410 about its major axis 410a. There are three objectives when determining which portions of the prolate spheroid to remove to generate the reflector surface 403a. First, to create a convenient surface for interfacing the reflector segment 403 to the circuit board section 402 that also positions the LED 401 at the location of the first focus point 404. Second, to create a structure that can be combined with the structures of the five other LED-reflector sections (see for example, FIG. 3B) to form a ring structure. Third, to provide an unobstructed area above and below the illumination area 406 that allows for collection of light from the illumination area 406. The collection of light from the illumination area 406 may be, for example, by an optical system for the purposes of imaging a sample in the illumination area 406 or for the purposes of direct detection of light from the illumination area 406.

FIGS. 5A-5D illustrate various views of a prolate spheroid surface generated by rotating an ellipse about its major axis and various truncation planes used to design an example embodiment of an example Prolate Spheroid Ring Illumination System. In particular, FIG. 5A shows a side view of the prolate spheroid 500 generated by rotating the ellipse 410 about its major axis 410a and a side view of a first truncation plane 501. Also shown are the first focus point 404, and the second focus point 405 that are shared by the prolate spheroid 500 and its generating ellipse 410. Portions of the prolate spheroid 500 that are above the first truncation plane 501 are drawn with a solid line and portions of the prolate spheroid 500 that are below the truncation plane 501 are drawn with a dotted line. A first truncation removes the portions of the prolate spheroid 500 that are shown with the dotted line.

FIG. 5B shows a top view of a truncated prolate spheroid 500a that is formed by the first truncation of the prolate spheroid 500 in FIG. 5A. FIG. 5B also shows the top view of a second truncation plane 502, the top view of a third truncation plane 503, the angle alpha 504 between the negative x-axis and the second truncation plane 502, and the angle beta 505 between the negative x-axis and the third truncation plane 503. The second truncation plane 502 and third truncation plane 503 intersect each other along the central axis 302 (not shown). Portions of the prolate spheroid 500a that are shown either above the second truncation plane 502 or below the third truncation plane 503 are drawn with a dotted line and are removed by the second and third truncations. For the ring reflector element 305 with six segments (see FIGS. 3A and 3B), each reflector segment 403 subtends 60 degrees and the angle alpha 504 and angle beta 505 are each 30 degrees.

FIG. 5C shows a top view of a truncated prolate spheroid 500b that is formed by the first, second, and third truncations of the prolate spheroid 500 shown in FIGS. 5A and 5B. FIG. 5C also shows a top view of a truncation cylinder 506, and the truncation cylinder radius 507. Portions of the truncated prolate spheroid 500b that are inside the truncation cylinder 506 are drawn with a dotted line to signify their removal by a fourth truncation. The truncation cylinder 506 is centered on the second focus point 405 and the radius 507 is chosen to optimize a tradeoff between maximizing amount of the LED emissions that are reflected while also allowing for an unobstructed view of the illumination area 406 from above.

FIG. 5D shows a perspective view of a resulting truncated prolate spheroid 500c that is formed by the first, second, third, and fourth truncations of the prolate spheroid 500 shown in FIGS. 5A-5C. FIG. 5D also shows the first focus point 404 and second focus point 405. The inner surface of the truncated prolate spheroid 500c defines the curvature and the extent of the reflector surface 403A shown in FIG. 4A.

### D. Re-Assembled Prolate Spheroid Ring Illumination System

Each one of the six LED-reflector sections 304 described in FIG. 3B is defined using the process described with respect to FIGS. 4A-5C and then arranged in a ring to form the PSRIS assembly 300 such that the second focus point 405 of all six LED-reflector sections 304 are located on the central axis 302 and at the center of the illumination area 303. Because the second focus point 405 of all six LED-reflector sections 304 is located at the center of the illumination area 303, all six LED-reflector sections 304 concentrate the reflected light to the single illumination area 303.

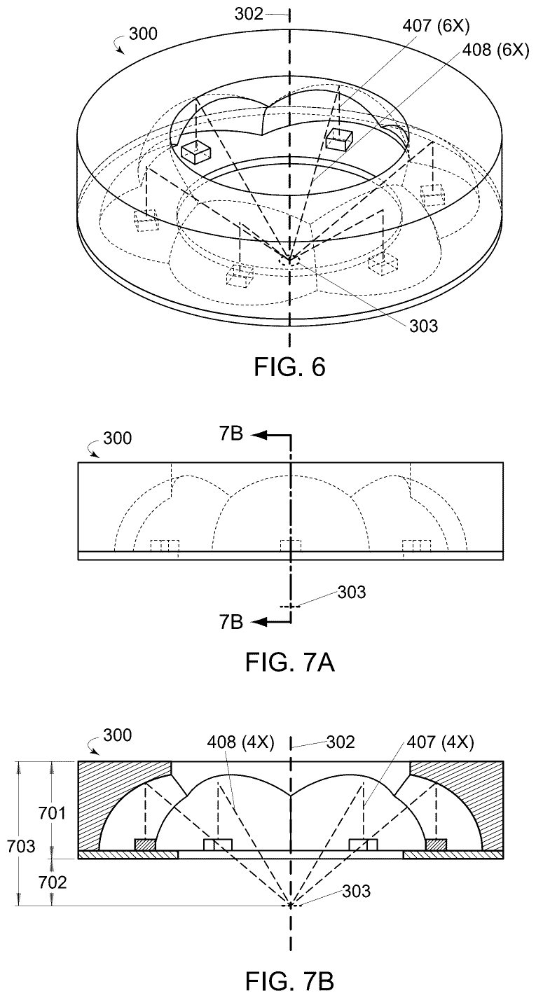

FIG. 6 is a perspective rendering of an example embodiment of an assembled Prolate Spheroid Ring Illumination System with six LED optical ray paths intersecting at an illumination area. FIG. 6 shows the PSRIS assembly 300, the assembly central axis 302, and the illumination area 303. FIG. 6 also shows the six LED central ray segments 407 and the six reflected ray segments 408, comprising the six optical ray paths, intersecting at the illumination area 303.

FIGS. 7A-7B shows a side view and a section view of an example embodiment of the example Prolate Spheroid Ring Illumination System. In FIG. 7A sectioning line 7B indicates the section view of the PSRIS 300 and the illumination area 303 shown in FIG. 7B. FIG. 7B shows the sectioned view of an example PSRIS with four LED central ray segments and four reflected ray segments (four optical ray paths). The PSRIS 300 shown includes four LED ray segments 407, four reflected ray segments 408, the central axis 302, the illumination area 303, and three distances 701-703. A unique property of the PSRIS is its compact form factor which allows it to fit within the working distance of many microscope objectives and to be used for illumination tasks where space is constrained. These aspects are described in further detail below with reference to a concept defined as “operational thickness.” FIG. 7B illustrates the concept of operational thickness in the abstract. The PSRIS assembly thickness 701 is the distance between the lowest point on the PSRIS 300 and the highest point on the PSRIS 300. The illumination working distance 702 is defined as the vertical distance between the lowest point on the PSRIS (the device exit aperture) and the illumination area 303. The operational thickness 703 demonstrated in FIG. 7B is thus the vertical distance between the highest point on the PSRIS 300 and the illumination area 303, which here is the sum of the PSRIS physical thickness 701 and illumination working distance 702.

The preceding figures show that it is possible to build a working PSRIS at a low cost with no moving parts that delivers a comprehensive set of advantages including but not limited to a thin profile, portability, high efficiency, reflected and transmitted modes in one integrated device, and the oblique illumination of a single illumination area with a uniform ring of radiance.

The operational thickness of an example PSRIS can be reduced by introducing one or more folds into the optical ray path (or ray path) between each illumination source and the illumination area. A fold is created when a reflection changes the overall propagation direction of a ray path such that the physical distance between optical elements can be reduced in comparison to an unfolded ray path of equivalent optical length.

As used herein, a fold in an optical path means a change in the sign of the longitudinal component of the propagation vector along the vertical axis between successive segments of a ray path, caused by a reflection, thereby reducing the physical distance between optical elements relative to an unfolded ray path of equivalent optical length.

Mathematically, let \hat{z} denote the axis along which operational thickness is measured. For each ray-path segment i of the ray path, define the propagation vector kᵢ. Equation (1) shows the relationship between the propagation vector kᵢ before a specular reflection at a surface with unit normal \hat{n} and the propagation vector kᵢ₊₁ after a specular reflection at a surface with unit normal \hat{n}.

$${k}_{i + 1} = {k}_{i} - 2 ( {k}_{i} \cdot \hat{n} ) \hat{n} \qquad ( 1 )$$

Equation (2) shows the relationship between the \hat{z} components of the propagation vectors before and after a reflection that results in a fold. A fold occurs when the sign of the \hat{z} component of the propagation vector kᵢ before reflection, and the sign of the \hat{z} component of the propagation vector kᵢ₊₁ after reflection are not equal:

$$sgn ( {k}_{i + 1} \cdot \hat{z} ) \neq sgn ( {k}_{i} \cdot \hat{z} ) \qquad ( 2 )$$

The fold count is the number of such sign changes between the illumination source and the illumination area. When a reflecting surface is curved, variations in the surface normal across the illuminated area can additionally alter the relative directions of adjacent rays so as to concentrate or diverge the illumination; such concentrating effects result from the geometry of the surface rather than from the fold condition described above.

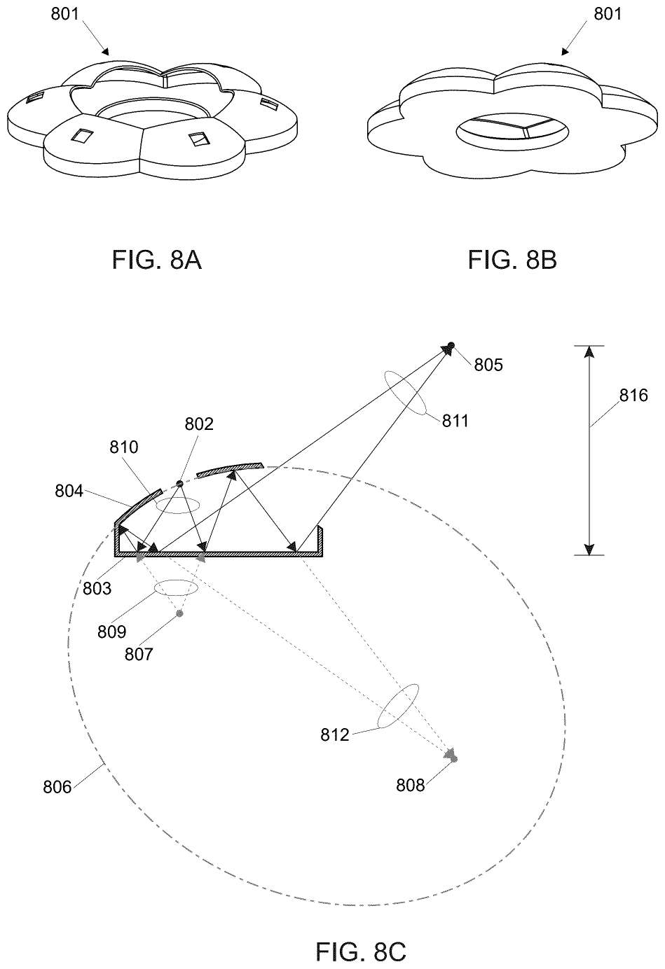

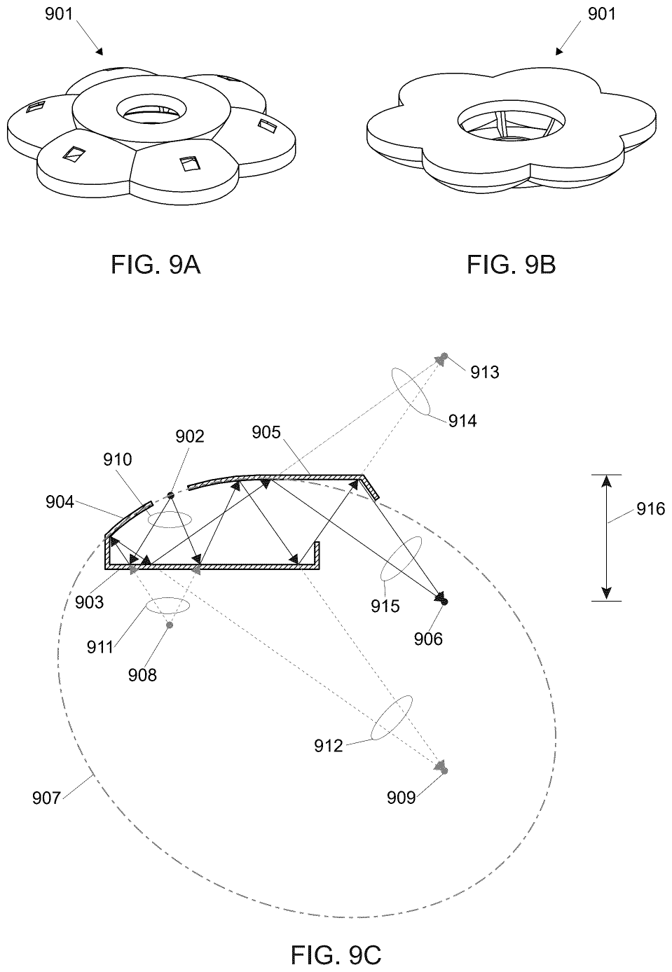

In one example embodiment (e.g., as shown in FIGS. 6 and 7B), one reflection is employed; this reflection both folds the ray path between each illumination source and the illumination area and also concentrates the illumination rays toward the illumination area. In a second example embodiment (e.g. as described further below with respect to FIG. 8C), three reflections are used: a first reflection to fold the path, a second reflection to both fold and concentrate the rays, and a third reflection to fold again. In a third example embodiment (e.g., as described further below with respect to FIG. 9C), four reflections are used: the sequence consists of a first fold, a second fold combined with concentration, a third fold, and a fourth fold. Other examples and example embodiments can be similarly constructed and varied based upon the number of reflections and geometry of reflective surfaces.

FIGS. 8A-8C show an example embodiment of the example Prolate Spheroid Ring Illumination System with two optical ray paths traveling from an illumination source to an illumination area using reflective surfaces to cause three folds. The three folds are created from three reflections of the rays from two reflective surfaces. Specifically, FIGS. 8A and 8B show top and bottom perspective views respectively of a first segmented compound ring reflector 801. FIG. 8C shows a slice section view of one of the six segments that combine to form reflector 801. Each segment of 801 has a light source (e.g., an illumination launch point such as an exit aperture from an optical fiber, LED, etc.) 802, a first reflective surface 803 with a planar surface profile, and a second reflective surface 804 with a surface profile that is, at least in one example embodiment, a section of a prolate spheroid surface. The reflective surfaces 803 and 804 of each segment are configured to concentrate rays diverging from the launch point 802 to an illumination point 805. The segments are configured together to form a ring such that each section's illumination point 805 is located at the same point in space (the illumination points from each section coincide with each other). FIG. 8C also shows the parent ellipse 806 of the prolate spheroid that defines the surface profile of surface 804, the first focus point 807 and second focus point 808 of parent ellipse 806, and sets of real and virtual rays as described below.

The performance of the segmented compound ring reflector 801 relies on a reflection property of prolate spheroids, where optical rays launched from a first focus point will converge at a second focus point after a single reflection emanating from the prolate spheroid surface. A unique condition exists when the first reflecting surface 803 is normal to and bisects (halfway) a line between the first focus point 807 and the launch point 802. In this case rays 810 launched from launch point 802 and after a first reflection from 803 appear to have been launched from the location of the first focus point 807 as shown by the first set of virtual rays 809 (shown as dotted lines). After a subsequent first reflection from the second reflecting surface 804, the rays are converging towards the second focus point 808 as shown by the second set of virtual rays 812 (shown as dotted lines). After a subsequent second reflection from the first reflective surface 803 the real rays 811 converge at the illumination point 805.

As shown in FIG. 8C, the planar first reflective surface 803 functions to create a virtual launch point at the location of the first focus point 807 and a virtual illumination point at the location of the second focus point 808. The term ‘virtual launch point’ refers to an apparent point of origin for rays, created by reflections from a reflective surface, such that the reflected rays behave as if they had originated from a focus of the prolate spheroid. This creates the condition where the launch point 802 and illumination point 805 satisfy the reflection property of prolate spheroid surfaces even though the launch point 802 and the illumination point 805 are not physically located at the positions of the first focus point 807 and second focus point 808 of the parent ellipse 806. The operational thickness of the first segmented compound ring reflector 801 is defined as the vertical distance 816 between the bottom surface of 801 (e.g., the first reflective surface 803) and the common illumination point 805. The planar first reflective surface 803 creates two folds in the optical ray path from launch point 802 to illumination point 805 which reduces the operational thickness distance 816 compared to designs that do not include the planar first reflective surface 803. It will be understood by those skilled in the art that, although FIGS. 8A-8C demonstrate the operation for optical ray paths in air, the reflector 801 could alternatively be made of a solid transparent material such as, for example, plastic or glass. In the latter case, optical rays launched from the launch point 802 enter the solid transparent material, propagate in the transparent material, undergo internal reflections at the surfaces with reflective coatings, and exit the material through an exit surface formed by the material to air interface. It will be further understood by those skilled in the art that, because there is an index of refraction difference at the material to air interface, the shape of the exit surface may be used to modify the convergence of the optical rays 811.

FIGS. 9A-9C show an example embodiment of the example Prolate Spheroid Ring Illumination System with two optical ray paths traveling from an illumination source to an illumination area using reflective surfaces to cause four folds. The four folds are created from four reflections of the rays from three reflective surfaces. Specifically, FIGS. 9A and 9B show top and bottom perspective views of a second segmented compound ring reflector 901. FIG. 9C shows a slice section view of one of the six segments that combine to form 901. Each segment of 901 has a light source (e.g., an illumination launch point such as an exit aperture from an optical fiber, LED, etc.) 902, a first reflective surface 903 with a planar surface profile, a second reflective surface 904 with a surface profile that is, in at least one example embodiment, a section of a prolate spheroid surface, and a third reflective surface 905 with a planar surface profile. The reflective surfaces 903, 904, and 905 of each segment are configured to concentrate rays diverging from the launch point 902 to an illumination point 906. The segments are configured together to form a ring such that each section's illumination point 906 is located at the same point in space (the illumination points from each section coincide with each other). FIG. 9C also shows the parent ellipse 907 of the prolate spheroid that defines the surface profile of surface 904, the first focus point 908 and second focus point 909 of parent ellipse 907, and sets of real and virtual rays that are described below.

The performance of the segmented ring reflector 901 relies on a reflection property of prolate spheroids, where optical rays launched from a first focus point will converge at a second focus point after reflection from the prolate spheroid surface. As described above with respect to FIG. 8C, a unique condition exists when the first reflecting surface 903 is normal to and bisects (halfway) a line between the first focus point 908 and the launch point 902. In this case rays 910 launched from launch point 902 and after a first reflection from 903 appear to have been launched from the location of the first focus point 908 as shown by the first set of virtual rays 911. After a subsequent first reflection from the second reflecting surface 904, the rays are converging towards the second focus point 909 as shown by the second set of virtual rays 912. After a subsequent second reflection from the first reflective surface 903 the rays are converging towards a second virtual illumination point 913 as shown by third set of virtual rays 914. After a subsequent reflection from the third reflecting surface 905, the real rays 915 converge at the illumination point 906.

As shown in FIG. 90, the first reflective surface 903 functions to create a virtual launch point at the location of the first focus point 908 and a virtual illumination point at the location of the second focus point 909. This creates the condition where the launch point 902 and illumination point 906 satisfy the reflection property of prolate spheroid surfaces even though the launch point 902 and the illumination point 906 are not physically located at the positions of the first focus point 908 and second focus point 909 of the parent ellipse 907. The operational thickness of the compound ring reflector 901 is defined as the vertical distance 916 between the top surface of 901 (e.g., the third reflective surface 905) and the common illumination point 906. The first reflective surface 903 functions to create two folds in the optical ray path from launch point 902 to illumination point 906 which reduces the operational thickness distance 916 compared to designs that do not have a folded path. The third reflective surface 905 functions to create a fourth fold in the optical ray path which further reduces the operational thickness distance 916 compared to designs that do not include the third reflective surface 905. It will be understood by those skilled in the art that although FIGS. 9A-9C demonstrate the operation for optical ray paths in air, the reflector 901 could alternatively be made of a solid transparent material such as for example plastic or glass. In the latter case, optical rays launched from the launch point 902 enter the solid transparent material, propagate in the transparent material, undergo internal reflections at the surfaces with reflective coatings, and exit the material through an exit surface formed by the material to air interface. It will be further understood by those skilled in the art that because there is an index of refraction difference at the material to air interface, the shape of the exit surface may be used to modify the convergence of the optical rays 915.

E. PSRIS with Optional Baffle

As mentioned above, a PSRIS can reduce the hazards associated with the use of UV light through the use of a multifunctional baffle in conjunction with the segmented prolate spheroid ring structure. Use of the baffle can prevent UV rays from exiting the illuminator through the reflector aperture (e.g., the aperture opposite the illumination area).

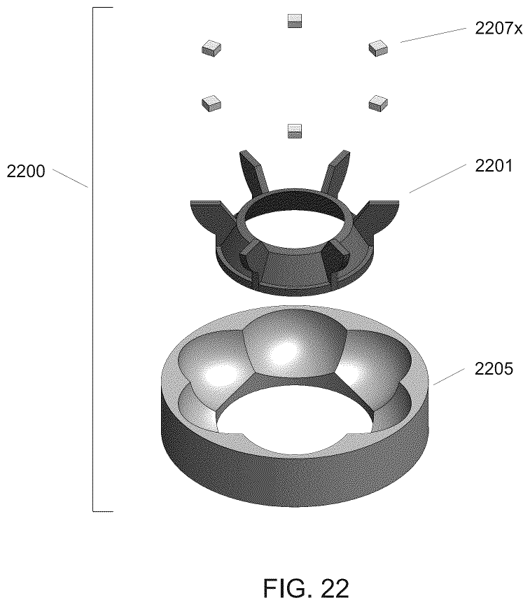

FIG. 22 is a rendering of an example embodiment of an example Prolate Spheroid Ring Illumination System that includes an optional multifunctional baffle. The PSRIS 2200 includes a PSRIS segmented prolate spheroid ring reflector 2205 (e.g., ring reflector 305 of FIG. 3A) and optional baffle 2201 along with LEDs 2207x (e.g., 307x of FIG. 3A).

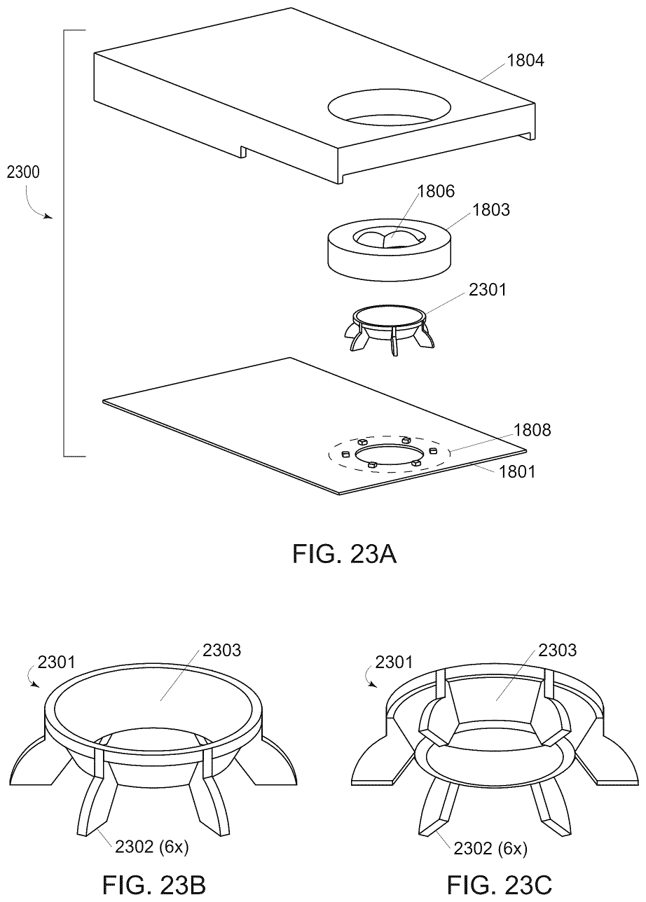

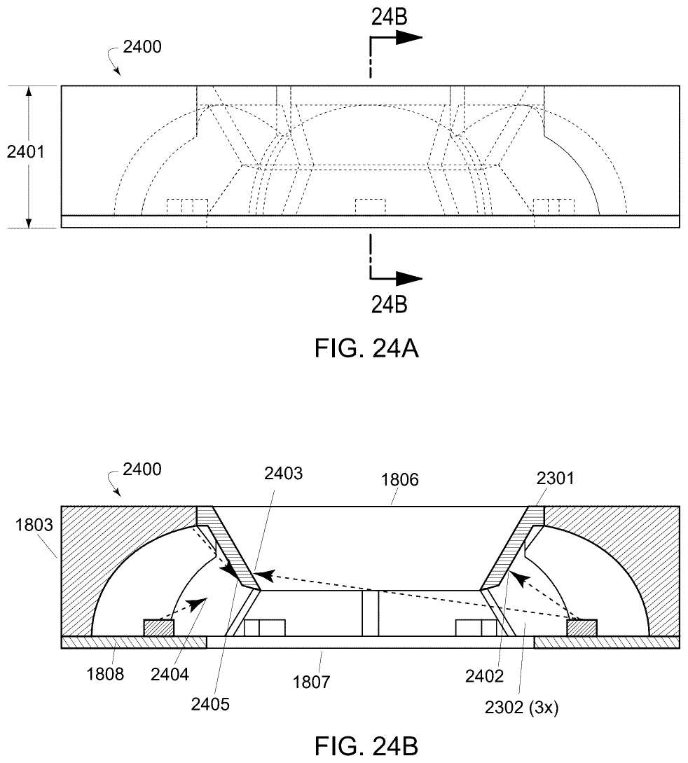

As described further below with respect to use of a PSRIS with a microscope and FIGS. 23A-24B, use of a baffle such as with PSRIS 2200 can prevent rays that are emitted from an LED in one section of the PSRIS assembly from entering an adjacent section. In addition, the baffle 2200 can prevent LED rays that are not incident on any reflector surface from undesired exiting of the PSRIS and undesired entering a non-adjacent section of the PSRIS assembly. The baffle 2200 can also prevents some reflected rays from reaching an illumination area.

### F. Optical Efficiency and Radiance Benchmark of a Prolate Spheroid Ring Illumination System

Two important optical characteristics of any illumination system are the efficiency with which it provides illumination to the desired area of illumination and the angles of the light rays that are incident on the desired area of illumination.

An optically efficient illuminator has many advantages relative to less efficient illuminators, including longer operating times for a given battery capacity, smaller batteries which result in cost and packaging advantages, smaller and lower power LEDs which results in cost and packaging advantages, less heat generation which results in packaging advantages and longer LED lifetimes, and less stray light generation which results in less optical noise in images.

The angular distribution of light rays illuminating an object can have significant impact on the characteristics and quality of the resulting image. Oblique illumination offers many advantages relative to on-axis illumination, including enhanced surface detail visibility which results in better detection of textures and fine features, increased contrast which improves the distinction between different surface elements, and the ability to reveal details in transparent or translucent materials that might otherwise be obscured. Oblique illumination reduces specular reflections, resulting in clearer images of reflective surfaces, and can also highlight subsurface features. In cases where the angle of all illumination is greater than the acceptance angle of the first optic in the imaging system the background light is eliminated.

Optical ray tracing software such as Zemax traces the path of rays through an optical system and uses these ray traces to model characteristics of the system including irradiance, optical efficiency, and angular distributions. Typically, millions of rays representing the output of optical sources are launched and traced through a system. Each ray can be considered to carry a fraction of the source's optical power. The irradiance, which is defined as the optical power per unit area, can be modeled by summing the power of all rays incident to a specified area and then dividing by the area. The optical efficiency to a specified area can be modeled by dividing the summed power of all rays incident to the area by the total optical power of the source. Incident radiance is the optical characteristic used to describe the angular distribution of light rays illuminating an area. The incident radiance to any specified area and for any specified angle of incidence is defined as the optical power per unit solid angle per unit area. The incident radiance can be modeled by summing the power of all rays that are incident to the specified area from a small cone centered at the specified angle of incidence and then dividing by the solid angle of the cone and the area. By repeating the incident radiance calculation for all elevation and azimuthal angles the full angular distribution of rays incident on an illumination area can be modeled. Ray tracing software can also produce rendered ray plots that show a representative subset of the traced rays. These rendered ray plots can provide a good intuitive understanding of the qualitative differences between different designs.

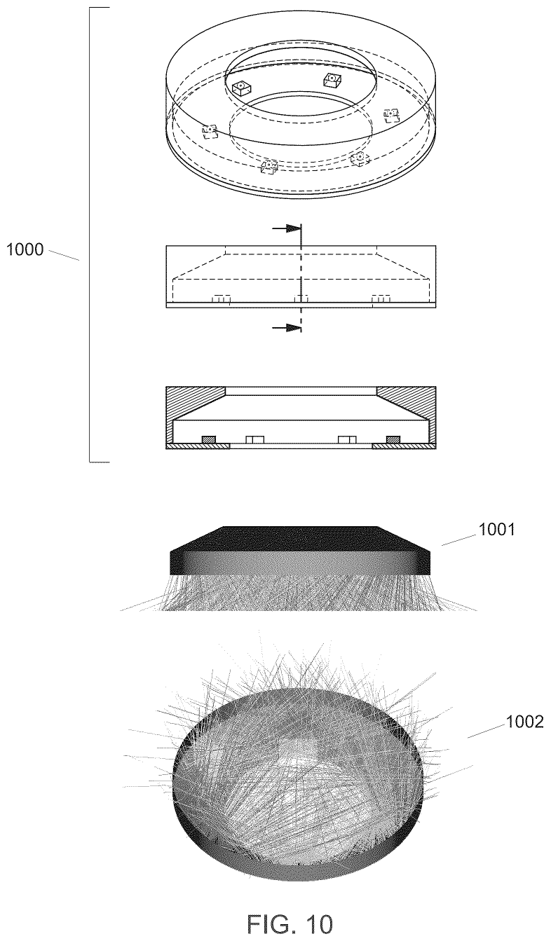

FIGS. 10-12 show Zemax ray plots that provide a qualitative comparison of the optical performance of the prolate spheroid reflector used in the Prolate Spheroid Ring Illumination System with two alternative reflector profiles. The first alternative reflector profile is a frustum (a truncated cone with the top removed by slicing in a plane parallel to the base). Existing examples that use the frustum reflector include that described in U.S. Pat. No. 6,554,452B1, titled “Machine-vision ring-reflector illumination system and method” issued Apr. 29, 2003, to Bourn et al. The second alternative reflector profile is a rotated ellipse. For the three reflector profiles compared in FIGS. 10-12, for illustration purposes, six point light sources are equally spaced around a 14 mm diameter ring and the thickness of each assembly is 4.7 mm.

Specifically, FIG. 10 shows a set of mechanical drawings and Zemax rendered ray plots for a frustum reflector assembly. The mechanical drawing set 1000 shows three views: oblique, side, and sectioned. The side view 1001 and the oblique bottom view 1002 of the rendered ray plots show that there is no concentration of the reflected rays which will result in low optical efficiency for illuminating a small area.

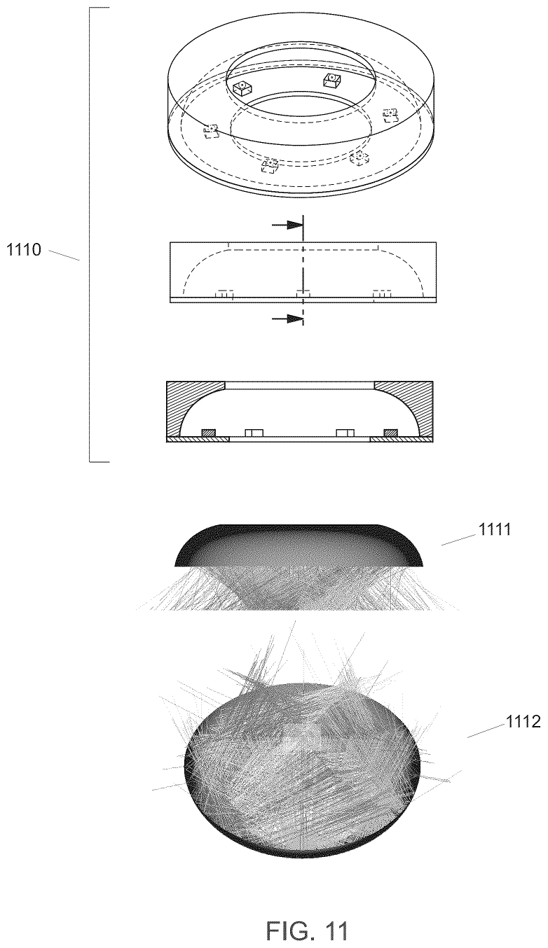

FIG. 11 shows a set of mechanical drawings and Zemax rendered ray plots for a rotated ellipse reflector assembly. The mechanical drawing set 1110 shows three views: oblique, side, and sectioned. The side view 1111 and oblique bottom view 1112 of the rendered ray plot show an improvement over the frustum reflector with at least some concentration of the rays (compare 1001 with 1111). However, the area of concentration is still large. The optical efficiency for illuminating a small area will be improved compared to the frustum but will still be low.

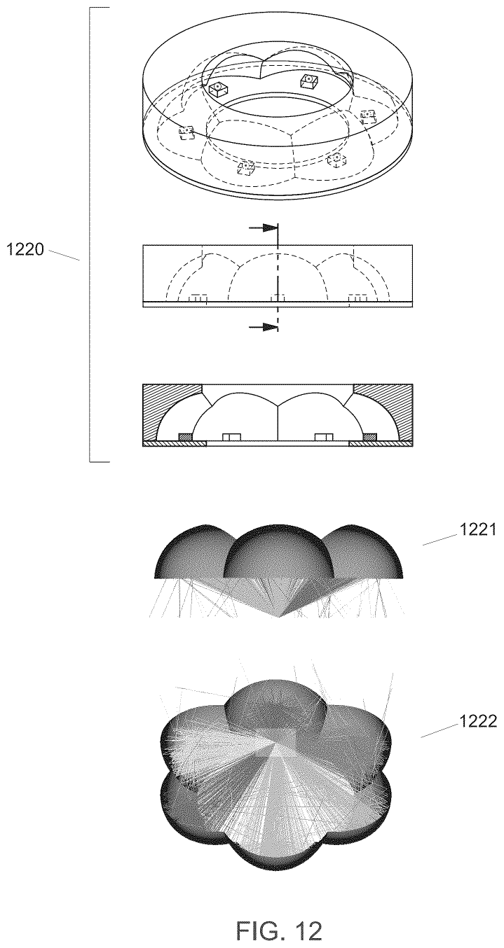

FIG. 12 shows a set of mechanical drawings and Zemax rendered ray plots for a six segment prolate spheroid reflector assembly of an example Prolate Spheroid Ring Illumination System. The mechanical drawing set 1220 shows three views: oblique, side, and sectioned. The side view 1221 and oblique bottom view 1222 of the rendered ray plot shows excellent concentration of the light rays to a small area in comparison to a frustrum reflector (view 1001) and a rotated ellipse reflector (view 1111). A comparison of the three sets of ray plots provides a visible illustration of why the prolate spheroid reflector will have significantly higher efficiency when illuminating a small area compared to the frustum reflector or rotated ellipse reflector.

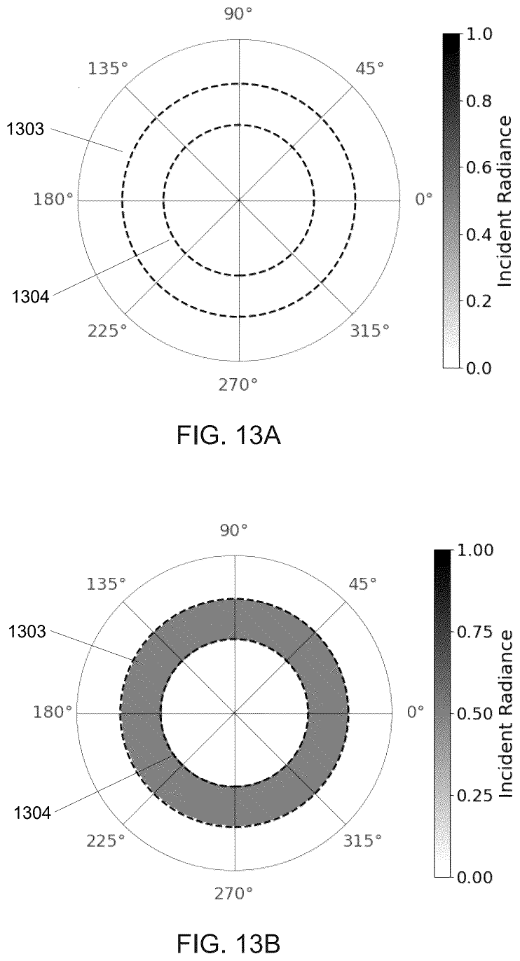

FIGS. 13A-13B show example incident radiance plots with zero uniform ring radiance and ideal uniform ring radiance. These are useful for describing a method of plotting the incident radiance or equivalently, the angular distribution of rays incident to a specified area. Specifically, FIG. 13A shows an empty polar plot with no radiance values plotted. The radial axis represents elevation angles from 0 to 90 degrees, where 0 degrees elevation is at the center and corresponds to the zenith or directly above the surface and 90 degrees elevation is at the outside edge and corresponds to the horizon. The circumferential axis represents azimuthal angles from 0 degrees to 360 degrees. The angle of a ray coming from any point in the hemisphere above the surface can be specified by its elevation and azimuthal coordinate values. The incident radiance, or equivalently the power per unit solid angle per unit area, coming from any set of elevation and azimuthal coordinates is given by the gray scale value at those coordinates according to the grayscale bar on the right side of each plot. The two dotted circles in FIG. 13A and FIG. 13B represent a full 360-degree ring of azimuthal angles bounded by 42 degrees elevation 1304 and 65 degrees elevation 1303. FIG. 13B plots a perfectly uniform 360-degree ring of radiance between 42 degrees elevation and 65 degrees elevation. To enable a single valued quantitative comparison of the uniformity of different incident radiance plots within a given range of elevation angles and over the full 360 degrees range of azimuth angles, we define an incident radiance uniformity factor as the percentage of angle space in the ring where the incident radiance is within 50% of the peak radiance value in the ring. For the ideal uniform ring incident radiance shown in FIG. 13B, the incident radiance uniformity factor is 100% between the elevation angles of 42 and 65 degrees.

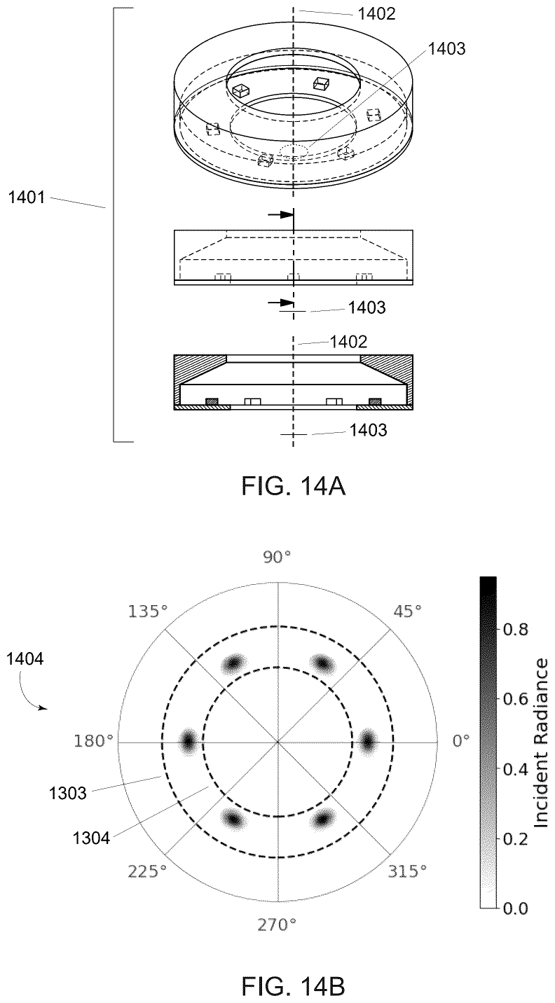

FIGS. 14-16 compare the incident radiance plots and the incident radiance uniformity factors for the Zemax models of the frustum reflector assembly, the rotated ellipse reflector assembly, and the six segment prolate spheroid reflector assembly of an example PSRIS. For this quantitative comparison, six 1 mm×1 mm LED sources with a Lambertian emission distribution are equally spaced around a 14 mm diameter ring and the thickness of each assembly is 4.7 mm. In each case the incident radiance is modeled for a 2 mm diameter illumination area located on a central axis of the LED ring and at a distance 2.3 mm from the bottom surface of the assembly. The Zemax modeled efficiencies are also compared for the same 2 mm diameter illumination area for each reflector assembly.

FIGS. 14A-14B shows the comparative radiance plots for a LED ring illumination device with a frustum reflector. Specifically, FIG. 14A shows an oblique, side, and sectioned view of a frustum LED-reflector assembly 1401 and a central axis 1402. The reflector surface is a frustum centered on the assembly's central axis 1402. A 2 mm diameter illumination area 1403 is also centered on the central axis 1402. FIG. 14B shows the corresponding modeled incident radiance plot 1404 for the illumination area 1403. The frustum reflector 1401 produces six patches of incident radiance (shaded areas on plot 1404) between the elevation angles of 42 degrees 1304 and 65 degrees 1303 and does not fill a substantial portion of either the elevation or the azimuthal angles (as can be seen by the discrete and sparse shaded areas that do not extend between the dotted lines). The incident radiance uniformity factor for the range of elevation angles from 42 to 65 degrees is 4% and the modeled efficiency is 0.6%.

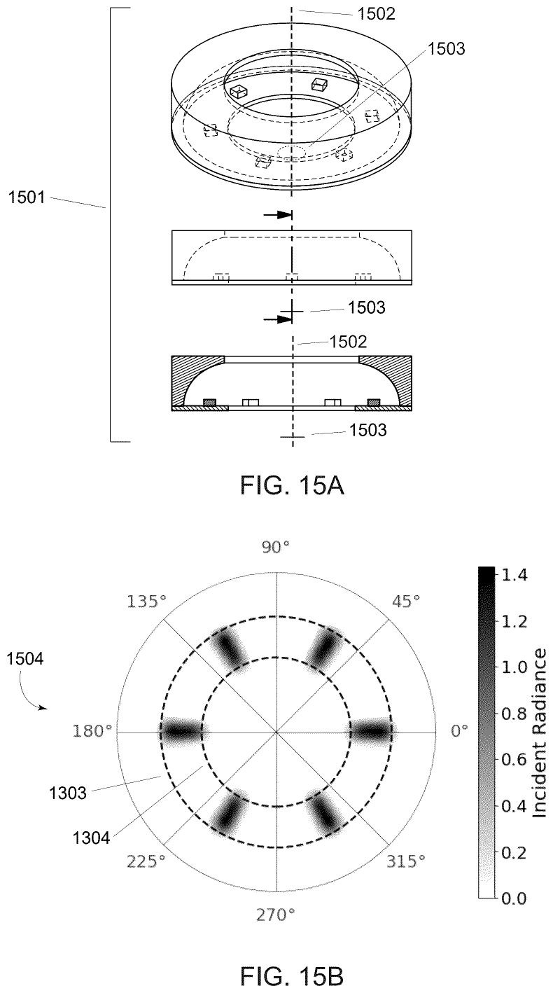

FIGS. 15A-15B shows the comparative radiance plots for a LED ring device with a rotated ellipse reflector. Specifically, FIG. 15A shows an oblique, side, and sectioned view of a rotated ellipse LED-reflector assembly 1501 and a central axis 1502. The reflector surface is a rotated ellipse centered on the assembly's central axis 1502. A 2 mm diameter illumination area 1503 is also centered on the central axis 1502. FIG. 15B shows the corresponding modeled incident radiance plot 1504 for the illumination area 1503. The rotated ellipse reflector 1501 produces a more desirable uniform radiance for the full range of elevation angles 42 degrees 1304 and 65 degrees 1303 as can be seen by the increased radii of the shaded areas on plot 1504, but only in six narrow ranges of azimuthal angles (see discrete and sparse shaded areas on plot 1504). The incident radiance uniformity factor for the range of elevation angles from 42 to 65 degrees is 13% and the modeled efficiency is 2.4%.

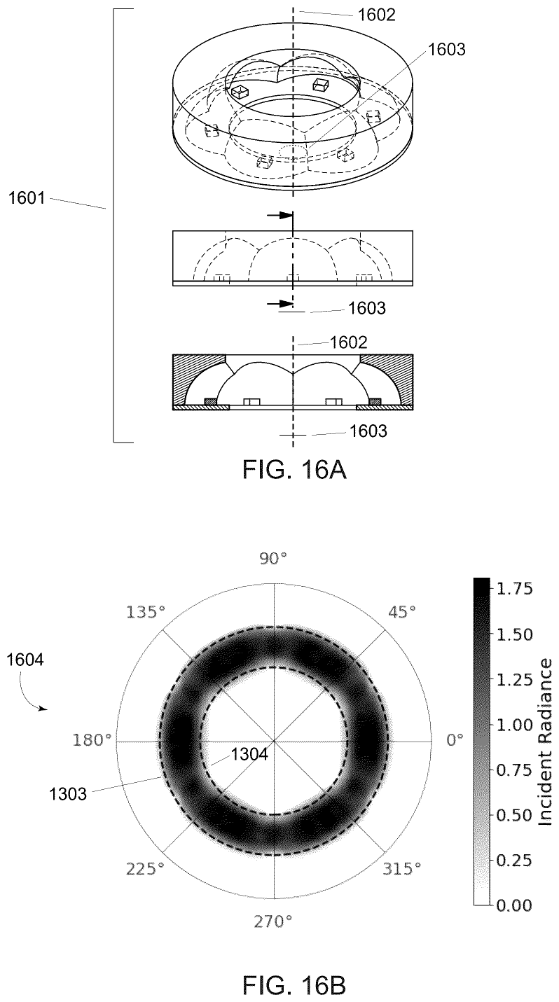

FIGS. 16A-16B shows the comparative incident radiance plots for an example embodiment of the example Prolate Spheroid Ring Illumination System. The structure of the LED-reflector assembly of a PSRIS with n-segment prolate spheroid reflectors optimizes both the optical efficiency and the incident radiance uniformity as compared to other designs. LED reflector assembly 1601 is a six segment prolate spheroid reflector assembly of an example PSRIS. FIG. 16A shows an oblique, side, and sectioned view of the six segment prolate spheroid LED-reflector assembly 1601 and a central axis 1603. The six segment prolate spheroid reflector is centered on the assembly's central axis 1603. A 2 mm diameter illumination area 1602 is also centered on the central axis 1603. FIG. 16B shows the corresponding modeled incident radiance plot 1604 for the illumination area 1602. As seen in FIG. 16B, the incident radiance is substantially uniform between 42 degrees 1304 and 65 degrees 1303 of elevation angles and over the full 360 degrees of azimuthal angles. The incident radiance uniformity factor for the range of elevation angles from 42 to 65 degrees is 86% and the modeled efficiency is 15%.

In the case of the PSRIS, the power incident on the illumination area comes from all 360 degrees of azimuthal angles and from a bounded range of elevation angles. This creates the ideal oblique illumination condition of illuminating a sample from all sides and minimizes shadowing. In addition, an ideal dark-field condition is created when illuminating a sample with a bounded range of elevation angles that are greater than the acceptance angle of the first optic in the imaging system. In the ideal dark-field condition produced by the PSRIS, the only light collected by the imaging system is light that is scattered, reflected, or emitted from the illuminated sample which results in an image of the object on a low noise dark background as opposed an image of the object on a bright background. High quality dark-field illumination that minimizes the background light is particularly advantageous when collecting weak images from a sample using electronic imaging systems. In these situations, long exposure times are used to capture the weak images and even low levels of background light can degrade the image.

Table 1 below shows a comparison of the optical efficiencies and the incident radiance uniformity factors for the six-segment prolate spheroid LED-reflector assembly of a PSRIS shown in FIGS. 16A-16B versus the two alternative LED-reflector assemblies shown in FIGS. 14A-15B. The segmented prolate spheroid LED-reflector assembly is both more efficient and has better incident radiance uniformity than the alternative structures.

TABLE 1

| | Absolute | Optical efficiency* | Radiance |
|---|---|---|---|
| | optical | relative to prolate | uniformity |
| Reflector Shape | efficiency* | spheroid | factor** |
| Six-segment | 15.4% | 100.0% | 86% |
| prolate spheroid | | | |
| Rotated ellipse | 2.4% | 15.6% | 13% |
| Frustum | 0.6% | 3.9% | 4% |

*Optical efficiency to a 2 mm illumination area
**To a 2 mm illumination area and within elevation range of 42 to 65 degrees

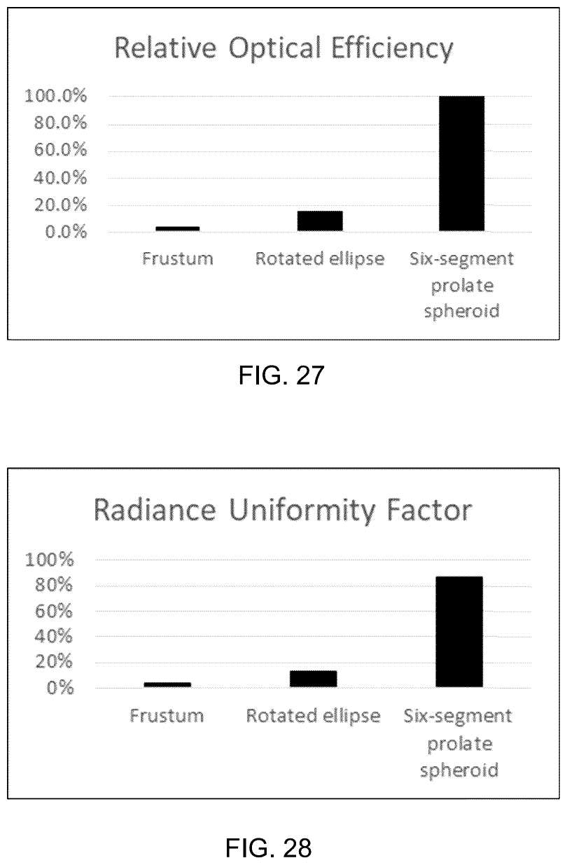

FIG. 27 is a chart illustrating the optical efficiency of an example Prolate Spheroid Ring Illumination System in comparison to a frustrum and to a rotated ellipse based upon the benchmarks shown in Table 1.

FIG. 28 is a chart illustrating the radiance uniformity factor of an example Prolate Spheroid Ring Illumination System in comparison to a frustrum reflector and to a rotated ellipse reflector based upon the benchmarks shown in Table 1.

### F. Prolate Spheroid Illumination System for Microscopes

As mentioned above, an example Prolate Spheroid Ring Illumination System (PSRIS) may be used for illumination with microscopes-even those not previously designed for such illumination. The structure and design of an example Prolate Spheroid Ring Illumination System for microscopes (PSRIS-M) provides an additional set of benefits specific to microscopes, including the following:

### 1. Uniform Ring Incident Radiance in Either Transmission Mode or Reflection Mode

The PSRIS-M provides the same uniform ring incident radiance in either transmission mode (e.g., illumination from below the sample) or reflection mode (e.g., illumination from above the sample) and in a way that is conveniently compatible with typical microscopes. Some samples can only be viewed in reflection mode. Other samples reveal different information when viewed in transmission mode compared to when viewed in reflection mode. It is often desirable to be able to easily change between illumination modes and in a way that allows the scope to operate within its intended range of adjustment. With the PSRIS-M, the user can rapidly switch between reflection mode and transmission mode by flipping the device over.

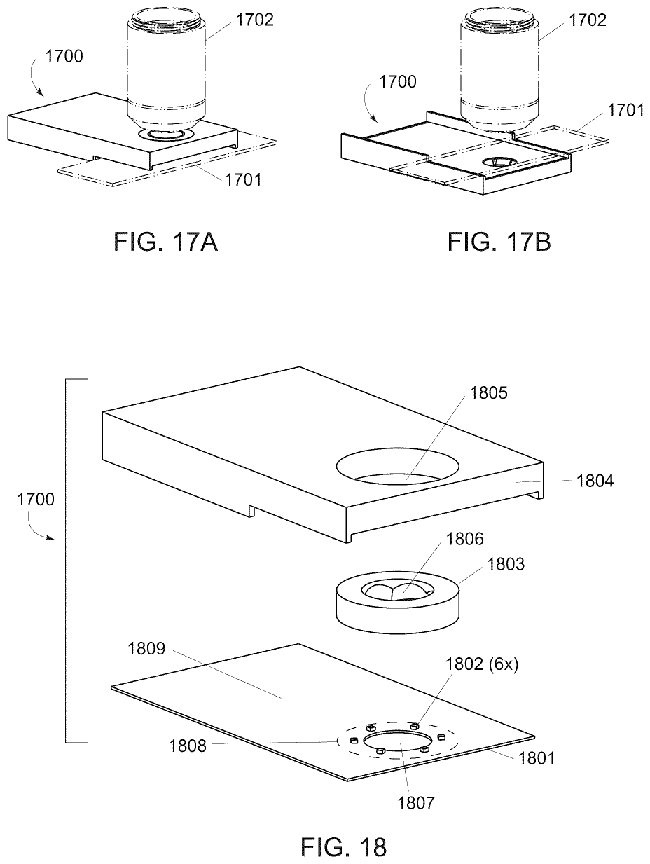

Example PSRIS-M devices include a housing design that allows the illuminator to rest on a flat surface in either of two orientations. In a first orientation, the illumination exits the illuminator directed towards the flat surface. The housing is configured to allow the LED-reflector ring to be positioned above the center of a microscope slide that is resting on the same flat surface. This provides reflected light illumination to the center of a slide. An example housing in reflection orientation is described below with respect to FIG. 17A. In a second orientation, the illumination exits the illuminator directed away from the flat surface (and towards the sample). The housing is configured to allow a slide with the sample to rest on features of the housing and be centered over the center of the LED-reflector ring. This provides transmitted light illumination to the center of the slide. An example housing in transmission orientation is described below with respect to FIG. 17B. The operational thickness is less than the available range of a typical microscope stage z-height adjustment, which is important for the transmission orientation and less than the working distance of many microscope objectives which is important for the reflection orientation. This allows a typical microscope to be properly focused on a slide both when the illuminator is in the first orientation and the slide is resting on the microscope table and when the illuminator is in the second orientation and the slide is resting on the illuminator.

### 2. No Z-Adjust Required for Reflection Mode or Transmission Mode

The PSRIS-M does not require z-direction adjustment (e.g., z-adjust) for either reflection mode or transmission mode due to the rails and surfaces built into the housing. For proper illumination of a sample, the illumination area must overlap the sample area. Because the PSRIS-M illumination converges towards the illumination area and diverges after passing through the illumination area, the illumination is concentrated over a small range of distance in z-height (<1 mm). Because the range of concentration in the z-direction is small, the relative position of the illumination area and the sample area needs to be aligned not only laterally (x, y), but also vertically (z). The PSRIS-M housing design ensures that the illumination area is optimally positioned vertically relative to the top surface of the slide without adjustment in both the reflection and transmission modes and thus significantly simplifies the use of the illuminator.

3. The Illuminator Resides within the Working Distance of the Microscope Objective

Due to the design of the PSRIS assembly, when operating in the reflection geometry, the illuminator resides within the working distance of the microscope objective. This eliminates the possibility that the oblique illumination will be obscured or blocked by the microscope objective regardless of the diameter of the objective and the angle of the oblique illumination. The segmented prolate spheroid ring configuration and the use of surface mount LEDs create a LED-reflector assembly with an operational thickness that is less than the working distance of many microscope objectives.

### 4. Portability

The PSRIS-M can be rapidly and readily swapped by a user between transmission and reflection modes and between microscopes and can be used with no attachment required. A typical microscopy laboratory or even many amateur microscopists will likely have several different microscopes with a range of illumination options. Only the most sophisticated professional laboratories will have microscopes with transmitted dark-field, reflected dark-field, and UV fluorescence. The PSRIS-M illuminator housing enables each of those illumination mode options and is compatible with a wide range of microscopes. The prolate spheroid reflector assembly structure enables a compact device that is small enough to rest on the stage of most microscopes. The efficiency of the prolate spheroid reflector assembly structure allows the illuminator to be powered by a rechargeable battery which simplifies setup by eliminating the need for corded operation. External features of the PSRIS-M housing allow it to operate in either of two orientations when resting on the same flat surface as a microscope slide and without attachment (e.g., a gravity mount) eliminating the need to install and interface with custom mounting hardware. Features of the housing as described above eliminate the need for relative height adjustment between the illuminator and the slide which saves alignment time.

FIGS. 17A and 17B illustrate an example embodiment of an example Prolate Spheroid Ring Illumination System for microscopes in different illumination orientations. FIG. 17A shows a Prolate Spheroid Ring Illumination System for microscopes (PSRIS-M) 1700 oriented to provide reflective light illumination to a sample area on a microscope slide 1701. In this orientation, the PSRIS-M 1700 is placed between microscope objective (lens system) 1702 and the slide 1701 holding the sample. FIG. 17B shows a PSRIS-M 1700 oriented to provide transmitted light illumination to a sample area on a microscope slide 1701. In this orientation, the slide 1701 holding the sample is placed between the PSRIS-M 1700 and the microscope objective 1702.

FIG. 18 is an exploded view of an example embodiment of an example Prolate Spheroid Ring Illumination System for microscopes showing primary components. Example embodiments of the example a (PSRIS-M) include a housing 1804, a circuit board 1801, and various PSRIS illuminator assembly components as described above (here shown as ring reflector 1803 and six LEDs 1802). The ring reflector 1803 has a central aperture 1806 and the housing 1804 has a central aperture 1805. In some example embodiments the ring reflector 1803 may be fabricated such that it is integral with the housing 1804. The circuit board 1801 has a first section 1808 for example for mounting LEDs 1802 and a second section 1809 for example for mounting components related to power and controls. The PSRIS-M housing 1804 has four functions. First, along with the circuit board 1801, the housing 1804 provides a partial enclosure for the PSRIS illuminator components (e.g., the illuminator assembly 300 in FIG. 3A) as well as the control and power electronic components (not shown). Power and control components can be either mounted to the circuit board or can reside in the space between the circuit board 1801 and the housing 1804. Second, features of the housing 1804 ensure that the LED-reflector central axis (e.g., axis 302 in FIG. 3A) is perpendicular to the slide 1701 for both the transmitted-light and reflected-light geometries. Third, in the reflected light geometry when the PSRIS-M 1700 and the slide 1701 are resting on the same flat surface (e.g., see FIG. 17A), features of the housing 1804 ensure that the illumination area (e.g., illumination area 303 in FIG. 3A) is located on the top surface of the microscope slide 1701. And fourth, in the transmitted light geometry when the slide 1701 is resting on the PSRIS-M 1700, features of the housing 1804 ensure that the illumination is concentrated on the top surface of the microscope slide 1701 after passing through the slide 1701. The PSRIS illumination assembly (e.g., assembly 300 in FIG. 3A) is mounted in the housing 1804 such that the top surface of the PSRIS illumination assembly does not extend beyond the top surface of the housing 1804.

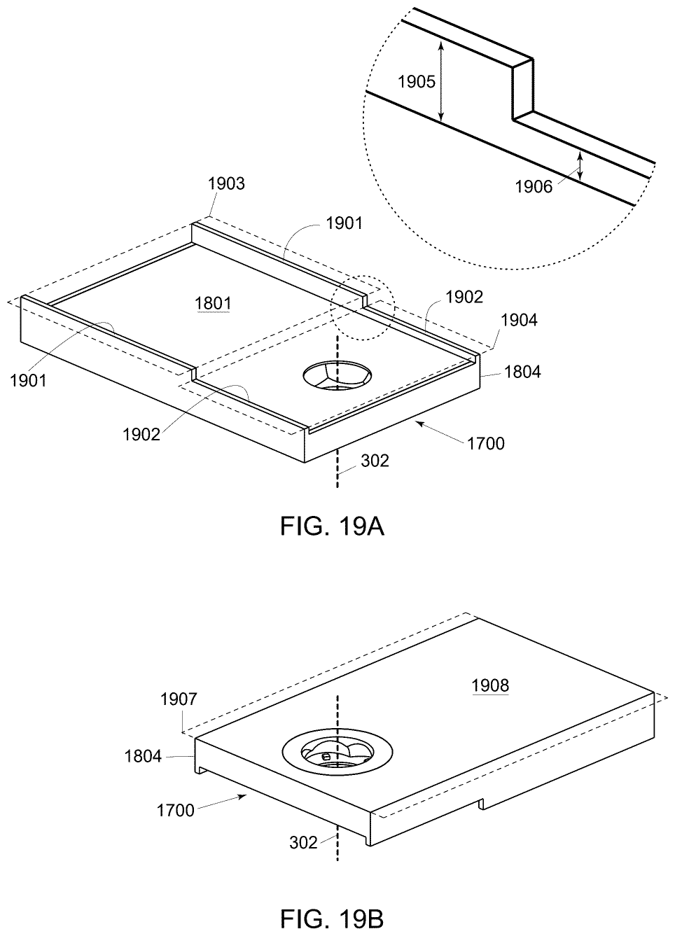

FIGS. 19A-19B illustrate several elements of an example housing of an example embodiment of an example Prolate Spheroid Ring Illumination System for microscopes and the planes defined therefrom. Specifically, the PSRIS-M 1700 includes three structural elements of the housing 1804 and shows three parallel planes defined by those elements. FIG. 19A shows a perspective view of an example PSRIS-M housing. Reflection mode rails 1901 extend a first distance defined as the reflection mode rail height 1905 above the circuit board 1801 on two sides of the housing 1804 and define a reflection mode plane 1903. The housing 1804 is configured such that the reflection mode plane 1903 is normal to the PSRIS central axis (e.g., central axis 302 of FIG. 3A). When orientated in the reflection illumination geometry, the reflection mode rails 1901 rest on a flat surface. This ensures that the central axis 302 is perpendicular to the surface and to a slide resting on the same flat surface.

FIG. 19A also shows transmission mode slide rails 1902 that extend a second distance defined as the transmission mode slide rail height 1906 above the circuit board 1801 on two sides of the housing 1804 and define a slide plane 1904. FIG. 19B shows a perspective view of a housing surface 1908 that is flat and defines a transmission mode plane 1907. The housing 1804 is configured such that the slide plane 1904 and the transmission mode plane 1907 are each normal to the LED-reflector central axis (e.g., central axis 302 of FIG. 3A). When oriented in the transmission illumination geometry, the housing surface 1908 rests on a flat surface. This ensures that the central axis is normal to the flat surface and to a slide resting on the slide rails 1902.

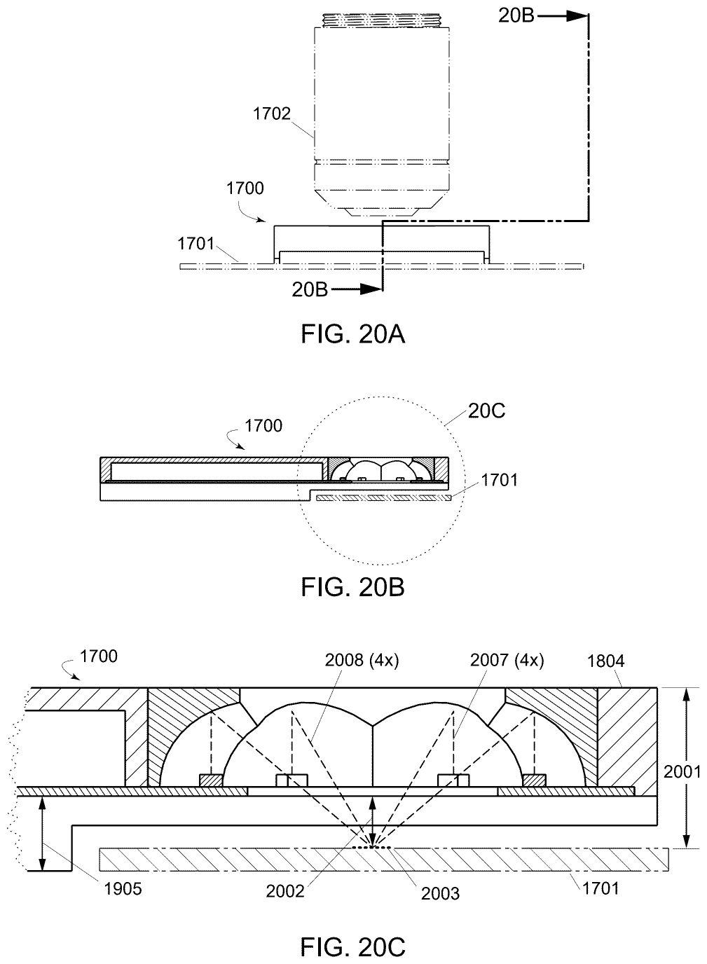

FIGS. 20A-20C show details of an example embodiment of an example Prolate Spheroid Ring Illumination System for microscopes oriented in the reflection illumination mode. In particular, FIG. 20A illustrates a front view of the PSRIS-M 1700 oriented in the reflection illumination geometry along with the microscope objective 1702, the microscope slide 1701, and a sectioning line corresponding to FIG. 20B. FIG. 20B shows the sectioned view of FIG. 20A and a region that is highlighted for detail in FIG. 20C. FIG. 20C shows the detail region of the PSRIS-M 1700 and slide 1701 section view that is called out in FIG. 20B, the four LED central ray segments 2007 of an optical ray path, the corresponding four reflected ray segments 2008, the illumination area 2003 (e.g., illumination area 303 in FIG. 3A), and PSRIS-M operational thickness 2001. The PSRIS-M 1700 operational thickness 2001 is defined as the vertical distance between the top surface of the housing 1804 and the illumination area 2003. When the top surface of the PSRIS (e.g., PSRIS 300 of FIG. 3A) is aligned with the top surface of the housing 1804, the PSRIS-M operational thickness 2001 is equal to the PSRIS operational thickness (e.g., operational thickness 703 of FIG. 7B). When the PSRIS-M 1700 and slide 1701 are oriented for reflected-light illumination and resting on the same flat surface as shown in FIG. 20C, the reflection mode rail height 1905 determines the vertical separation between the illumination area 2003 and the top surface of the slide 1701. The reflection mode rail height 1905 is chosen to be equal to the sum of the illumination working distance 2002 (e.g., working distance 702 of FIG. 7B) and the slide 1701 thickness. This ensures that the illumination area 2003 is located on the top surface of the slide 1701 without adjustment of the vertical separation between the slide 1701 and the PSRIS-M 1700.

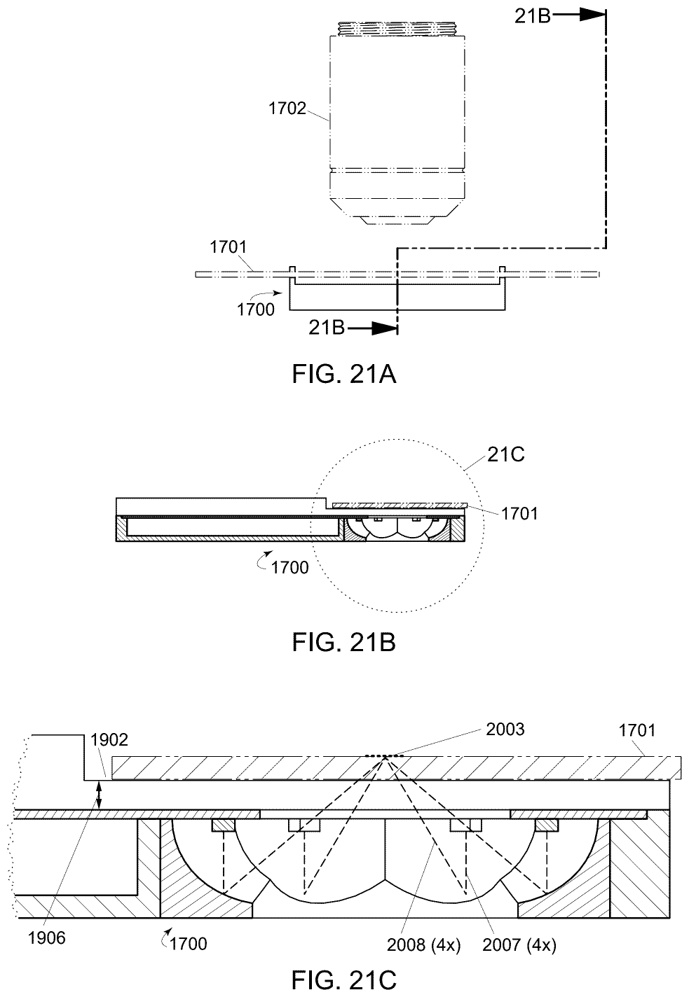

FIGS. 21A-21C show details of an example embodiment of an example Prolate Spheroid Ring Illumination System for microscopes oriented in the transmission illumination mode. In particular, FIG. 21A illustrates a front view of the PSRIS-M 1700 oriented in the transmission illumination geometry along with a microscope objective 1702, microscope slide 1701, and a sectioning line corresponding to FIG. 21B. FIG. 21B shows the sectioned view of FIG. 21A and a region that is highlighted for detail in FIG. 21C. FIG. 21C also shows the detail region of the PSRIS-M 1700 and slide 1701 section view that is called out in FIG. 21B, the four LED central ray segments 2007, the corresponding four reflected ray segments 2008, and the illumination area 2003 (e.g., illumination area 303 in FIG. 3A). When the PSRIS-M 1700 and slide 1701 are oriented for transmission-light illumination with the slide 1701 resting on the slide rails 1902 as shown in FIG. 21C, the slide rail height 1906 determines the vertical separation between the illumination area 2003 and the top surface of the slide 1701. The slide rail height 1906 is chosen such that the illumination area 2003 is located on the top surface of the slide 1701 for illumination that has passed through the slide 1701.

### G. Operational Thickness

A distinguishing characteristic of both the PSRIS and the PSRIS-M is that they can be configured as thin devices that concentrate illumination from multiple illumination sources to an illumination area located very close to the device. This permits fabrication of an illuminator that is measurably thinner than would otherwise be possible using known fabrication methods. This characteristic is described by the term “operational thickness.” Operational thickness provides a way to measure how “tall” the illumination device is in the part that actually matters for fitting it into an imaging system. The concept of operational thickness relates to the amount of space either above or below a sample plane that the illuminator occupies when positioned to provide illumination to a sample plane.

First, imagine a vertical cylinder centered on the device's central axis (the axis going through the middle of the illumination area and the device's exit aperture). The radius of this cylinder, R, is chosen so that it is just large enough to include the area that might bump into or block the imaging objective lens when the device is being positioned or is in use.

Operational thickness is the total height in this cylinder, measured from the illumination area up (or down, for inverted setups) to the tallest part of the device inside that cylinder. Accordingly, “operational thickness” means the sum of:
(a) the physical thickness of the device within a cylindrical region centered on the central axis and having a radius R, where R is chosen to encompass any portion of the device that may interfere with an imaging system's objective lens; and
(b) the distance from the device's exit aperture to the illumination area (i.e., the gap or illumination working distance).

The cylindrical region is coaxial with the central axis and extends vertically through the device. Device structures located outside this cylindrical region—such as housings for batteries, electronics, or other components—are excluded from the operational thickness, as they do not interfere with an imaging system's objective lens or affect positioning for illumination.

As shown in FIG. 7B, the operational thickness 703 of the PSRIS 300 is given as the sum of the PSRIS physical thickness 701 and the illumination working distance 702 (which is the distance between the device exit aperture and the illumination area). In applications where the PSRIS illuminates a sample from above (e.g., reflective mode in a PSRIS-M such as shown in FIG. 17A), the operational thickness is the vertical distance upward from the illumination area to the top surface of the PSRIS. In applications where the PSRIS illuminates a sample from below (e.g., transmission mode in a PSRIS-M such as shown in FIG. 17B), the operational thickness is the vertical distance downward from the illumination area to the bottom surface of the PSRIS.

As well, as shown in FIG. 20C, the PSRIS-M operational thickness includes any additional distance (thickness) contributed by the housing in the applicable region (within the imaginary cylinder defined above). In some configurations, the PSRIS-M housing can be arranged so that it adds no thickness, making the operational thickness of the PSRIS-M equal to that of the PSRIS.

Operational thickness can be an important design parameter in applications where the PSRIS is integrated into or retrofitted to operate with other instruments, such as wearable devices or point-of-care diagnostic imagers, where reduced thickness improves ergonomics, portability, and integration into compact systems. For the PSRIS-M, operational thickness can determine whether the device can be used with a given existing microscope.

As shown in FIG. 17A for reflected-light illumination in a non-inverted microscope, the PSRIS-M 1700 is positioned between a microscope slide 1701 and a microscope objective 1702 that collects light from a sample mounted on slide 1701. In this case, the operational thickness must be less than the working distance of the objective lens (e.g., the distance between the objective lens and the sample). As shown in FIG. 17B for transmitted-light illumination in a non-inverted microscope, the PSRIS-M 1700 rests on a microscope stage below a sample mounted on a microscope slide 1701, with the slide resting directly on the device 1700. In this arrangement, the stage must have sufficient range of travel to lower by at least the operational thickness so the sample can be brought into the focal plane of the objective.

### H. Example PSRIS-M Variations

In a first example PSRIS-M 1700, the PSRIS-M operational thickness 2001 and the PSRIS operational thickness (e.g., operational thickness 703 of FIG. 7B) are both 7.05 mm. The illumination working distance 2002 (e.g., working distance 702 of FIG. 7B) is 2.29 mm. This example PSRIS-M 1700 has six 4000K LEDs surface mounted to a 0.80 mm thick circuit board. An example usable LED is, LED part number L130-4090001400001 although others may be similarly incorporated. The PSRIS-M 1700 is configured to provide concentrated illumination to the top surface of a 1 mm thick microscope slide 1701 when the PSRIS-M 1700 is oriented in the reflection mode geometry and resting on the same flat surface as the slide 1701. The PSRIS-M 1700 is further configured to provide concentrated illumination to the top surface of a 1 mm thick microscope slide 1701 when the PSRIS-M 1700 is oriented in the transmission mode geometry with the microscope slide 1701 resting on the slide rails 1902.

The values needed to define the curvature and extent of the truncated prolate spheroid surface (e.g., in FIG. 4A, surface 403a of each LED reflector section 400 of the PSRIS 300 of FIG. 3A) for constructing the first example PSRIS-M are given in Table 2 along with the reflection mode rail height 1905 and the slide rail height 1906. The construction values for each LED reflector section (e.g., section 400 of FIG. 4A) are given for that section located in the coordinate system shown in FIG. 4 with the radial bisector of the section in the x-z plane. The sections are then combined to form a ring structure with each section's second focus point (e.g., second focus point 405 in FIG. 4A) placed at the same location on the central axis (e.g., central axis 302 in FIG. 4A). In the first example PSRIS-M 1700 each of the six prolate spheroid surfaces (e.g., surface 403a in FIG. 4A) have the same curvature and extent and therefore each section can be constructed using the same set of construction values. The references in Table 2 below refer to FIG. 4, FIG. 5, FIG. 19, and their associated values.

TABLE 2
Prolate spheroid surface 403a curvature in coordinates of FIGS. 4A, 4B
coordinates of first focus point 404: x = −7.10 mm, y = 0 mm, z = 3.24
mm
coordinates of second focus point 405: x = 0 mm, y = 0, z = 0 mm
angle theta 409: 49.3 degrees
angle phi: 0 degrees
Prolate spheroid surface 403a extent in coordinates of FIGS. 5A-5D
First truncation plane 506: z = 2.44 mm
angle alpha 504: 30 degrees
angle beta 505: 30 degrees
truncation cylinder radius 507: 4.6 mm
Housing rail heights (FIG. 19A)
reflection mode rail height 1905: 3.3 mm
slide rail height 1906: 1.3 mm

A second example PSRIS-M uses three 4000K LEDs and three 365 nm UV LEDs. The 4000K LEDs and UV LEDs are arranged to alternate in the PSRIS (e.g., PSRIS 300 of FIG. 3A) such that adjacent LED-reflector sections do not have the same LED type. An example usable 4000K LED part number is L130-4090001400001 and an example usable 365 nm LED part number is Kingbright ATS2012UV365, although other parts may be similarly incorporated. The PSRIS-M operational thickness 2001, the LED-reflector operational thickness (e.g., operational thickness 703 of FIG. 7B), illumination working distance 2002 (e.g., working distance 702 of FIG. 7B), and construction values for a PSRIS-M shown in Table 2 are the same as those given for the first example PSRIS-M.

It will be understood by those skilled in the art that many variations of components and construction values are possible including the number of LEDs and reflector segments, LED type and wavelength, prolate spheroid surface curvature and extent, reflection mode rail height 1905, slide rail height 1906, angle theta (409 in FIG. 4B) and angle phi. It will be further understood that different combinations of these and other variations may result in variations in the resulting operational thickness and illumination working distance.

I. Prolate Spheroid Ring Illumination System for Microscopes with Baffle

In an example embodiment of an example PSRIS for microscopes (PSRIS-M), referring to FIG. 4A, each LED-reflector section 400 is constructed such that a high percentage of rays emitted from that section's LED 401 are incident on that section's reflector surface 403a and are reflected towards the illumination area 406. However, many LED types emit a small percentage of rays at high angles relative to the normal to the LED 401 and these high angle rays may not be incident on the corresponding reflector surface 403a. For some illumination tasks, rays that are not incident on a given LEDs corresponding reflector surface 403a can degrade the performance of a PSRIS-M (such as PSRIS-M 1700 in FIGS. 17A-21C) or cause other unwanted effects. In a first case, a small percentage of rays can exit the PSRIS-M 1700 directly through the reflector aperture 1806 (see FIG. 18) without reflecting from the reflector surface 403a. If collected by an imaging system, these rays may contribute to background noise. In a situation when UV LEDs are being used, these rays can also contribute to an eye or skin safety hazard if allowed to exit the PSRIS-M. In a second case, rays that are not incident on the intended reflector surface 403a may be incident on areas in an adjacent section of the PSRIS ring reflector 1803 such as the adjacent circuit board section, adjacent reflector surface, or adjacent LED. In a third case, rays that are not incident on the intended reflector surface 403a may be incident on a non-adjacent reflector surface. Reflections or scattering of rays from adjacent or non-adjacent sections may result in unwanted stray light in the illumination area 406 and surrounding areas. Rays that are incident on an adjacent or non-adjacent LED may also result in unwanted fluorescence which can be efficiently concentrated to the illumination area 406. The chance of unwanted fluorescence being efficiently coupled to the illumination area 406 is highest when the PSRIS illumination assembly (e.g., PSRIS assembly 300 in FIG. 3A) is configured with both UV LEDs and white LEDs.

To prevent the performance of the PSRIS-M (e.g. PSRIS-M 1700 in FIGS. 17A-21C) from being degraded in either the first case, the second case, or the third case, a structure that blocks the unwanted rays can be added to PSRIS-M 1700. In the first case the unwanted rays should be blocked before they exit the PSRIS-M 1700. In the second case and the third case the unwanted rays should be blocked before they enter an adjacent or non-adjacent section. In a fourth case it may be desirable to block some rays from reaching the illumination area 406 that are reflected from the intended reflector surface 403a. In normal operation the rays incident to the illumination area from each LED-reflector section 400 will have a range of incident angles. In some cases, it may be desirable to restrict the range of incident angles of the rays incident on the illumination area 406. In these cases, a structure that blocks rays with unwanted incident angles can be added to the PSRIS-M 1700 such as baffle 2201 shown in FIG. 22 and described earlier with respect to a PSRIS having an optional baffle.

FIG. 23A illustrates an exploded view of an example Prolate Spheroid Ring Illumination System for microscopes that includes an optional multifunctional baffle. PSRIS-MB 2300 includes an optional multifunctional baffle element 2301. The PSRIS-MB 2300 is constructed in a similar fashion to the PSRIS-M 1700 and can use the identical housing 1804, reflector 1803, and circuit board 1801 as the PSRIS-M 1700. When assembled, the multifunctional baffle element 2301 nests in the region between the circuit board 1808 and the reflector 1803 and becomes part of a baffled PSRIS. (In other embodiments baffle element 2301 may be integrated into and with the reflector 1803.)

FIGS. 23B and 23C show two views of the multifunctional baffle element 2301 of FIG. 23A. The baffle has four optical functions. A group of six baffle fins 2302 prevent rays that are emitted from an LED in one section of the PSRIS assembly from entering an adjacent section. A truncated baffle cone 2303 has three functions. The truncated baffle cone 2303 prevents LED rays that are not incident on any reflector surface from exiting the PSRIS-M 1700 through the reflector aperture 1806 and prevents LED rays that are not incident on any reflector surface from entering a non-adjacent section of the PSRIS assembly. The truncated baffle cone 2303 also prevents some reflected rays from reaching the illumination area 2003.

FIG. 24A-24B illustrate a side view of an optional multifunctional baffle used with an example Prolate Spheroid Ring Illumination System for microscopes and a detail section thereof. In particular, FIG. 24A shows a side view of the assembled baffled PSRIS-M 2400 and a 24B sectioning line. Because the multifunctional baffle element 2301 nests in the region between the circuit board section 1808 and the reflector 1803 and becomes part of a baffled PSRIS 2400, the baffled PSRIS thickness 2401 is the same as the unbaffled PSRIS thickness (e.g., thickness 701 in FIG. 7B) and therefore the thickness of the baffled PSRIS-M 2300 is not increased compared to the thickness of the unbaffled PSRIS-M 1700.

FIG. 24B shows a sectioned view of the baffled PSRIS-M shown in FIG. 24A and four types of baffled rays. The bottom surface of the baffle fins 2302 rest on the circuit board section 1808 and the baffle fins 2302 form side walls for each section of the PSRIS assembly that prevent optical crosstalk between adjacent sections. The baffle cone 2303 (see FIG. 23B) is held a distance above the circuit board 1808 by the baffle fins 2302. The top edge of the baffle cone 2303 fits inside the reflector aperture 1806 and is flush with the top of the reflector assembly 1200. A first baffled ray 2402 is not incident on the reflector and is prevented from exiting through the reflector aperture 1806 by the baffle cone 2303. A second baffled ray 2403 is not incident on the reflector and is prevented from entering a non-adjacent section by the baffle cone 2303. A third baffled ray 2404 is not incident on the reflector and is prevented from entering an adjacent section by one of the baffle fins 2302. A fourth baffled ray 2405 is reflected and is then blocked by the baffle cone 2303 before exiting through the circuit board aperture 1807.

### J. Prolate Spheroid Ring Illumination System for Point-of-Care Devices

Point-of-care (POC) testing is medical diagnostic testing performed at the point of care, meaning at the time and place of patient care. Used in doctors' offices, hospitals, in patients' homes, and in the field, POC diagnostic devices give quick feedback on many kinds of medical tests. This is in contrast to testing performed in the medical laboratory which requires specimens to be sent to a laboratory and usually entails waiting hours, days or even weeks to learn the results. There are many advantages to doing tests at the point of care, including lower costs, quicker results, and faster implementation of therapy, if needed.

The general POC device category includes a subset of devices that include microscopy-enabled subsystems. These are often referred to as vision-enabled POC devices. Point-of-care devices that utilize microscopes are designed to offer rapid diagnostic capabilities at or near the site of patient care and are invaluable in various medical and patient care settings. Example POC devices with internal microscope systems include:

Blood Cell Analyzers. These devices use microscopic imaging to count and analyze blood cells, providing information on red and white blood cell counts, platelet levels, and identifying abnormalities. Examples include certain models of hematology analyzers.

Urine Microscopy Analyzers. These are used to analyze urine samples for the presence of cells, crystals, bacteria, and other substances. They often employ microscopic imaging to provide detailed information about the urinary tract.

Rapid Diagnostic Microscopes: These portable microscopes are used in various fields, including infectious disease diagnosis. For instance, devices for malaria diagnosis use microscopy to detect Plasmodium parasites in blood samples.

Point-of-Care Microscopy for Wound Care: Some devices use microscopy to assess wound infections or healing processes. These can help in identifying microorganisms in wound samples quickly.

Handheld Microscope Devices: Some advanced handheld devices combine microscopy with other diagnostic tools for quick assessments, like evaluating skin conditions or other surface-level issues. These include mobile phone based devices.

These devices leverage microscopy to provide quick, on-site analyses, improving patient outcomes by facilitating timely and accurate diagnosis.

An additional class of devices known as bio-medical mobile workstations can be used for the prevention of epidemic viruses and bacteria, outdoor field medical treatment, and bio-chemical pollution monitoring. In these devices microscopic imaging equipment has traditionally been quite limited. The comprehensive multi-mode illumination such as bright/dark field imaging, UV fluorescence excitation imaging and other light imaging used in typical benchtop biomedical microscopy imaging systems for this application are generally expensive and large in size and thus not appropriate for POC imaging devices. They also require professional operation, which results in higher cost. Bio-medical mobile workstations need microscopy systems which are compact, inexpensive and able to handle fast, timely and large-scale deployment. Accordingly, the development of lightweight, low-cost and portable microscopic illumination such as that provided by the example PSRIS embodiments as described here can help meet these demands in the POC market.

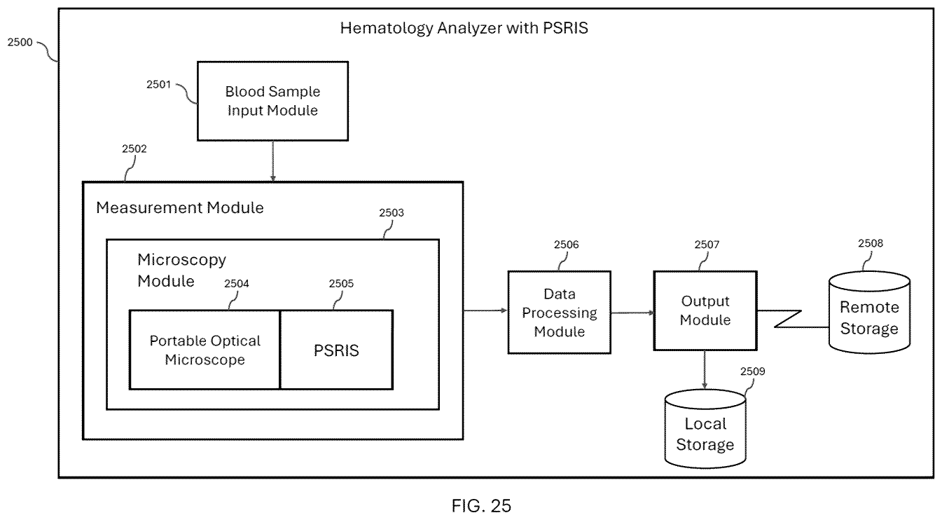

FIG. 25 is an example block diagram of an example point-of-care device incorporating a microscope subsystem that incorporates an example Prolate Spheroid Ring Illumination System. Specifically, FIG. 25 shows a hematology analyzer 2500 that incorporates a subsystem blood sample input module 2501 which accepts the blood sample. The blood sample is then analyzed by the measurement module 2502. The measurement module 2502 incorporates a microscopy module 2503 which has an optical microscope 2504. Illumination for the optical microscope 2504 is provided by the PSRIS 2505. Measurements from the measurement module 2502 are passed to the data processing module 2506 and then results are sent to the output module 2507 where they can be send via a data connection to remote storage 2508 and/or stored in local storage 2509.

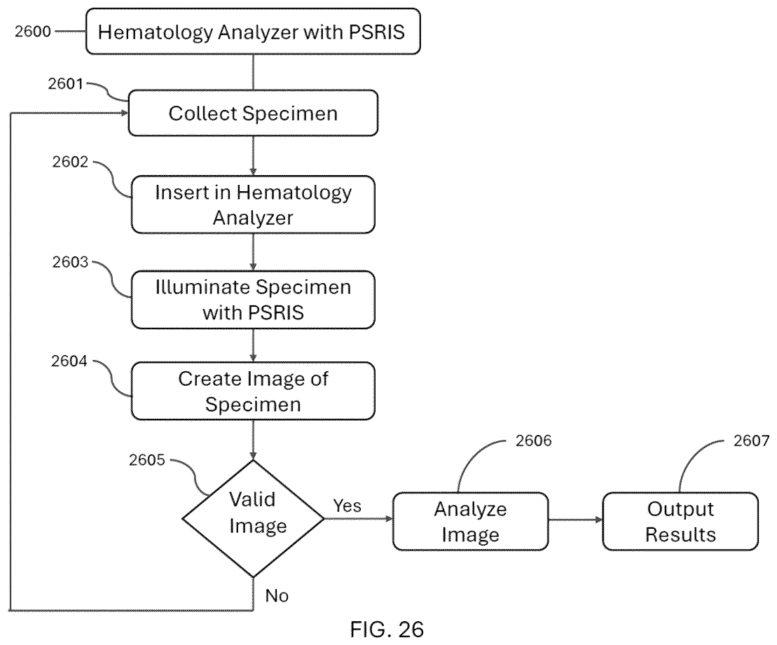

FIG. 26 is an example flow diagram of logic for an example embodiment of an example point-of-care device that incorporates an example Prolate Spheroid Ring Illumination System. Specifically, FIG. 26 shows a hematology analyzer 2600 wherein the blood sample (specimen) is collected. In block 2601 an operator, such as a medical professional or in some embodiments the patient themselves, collects the specimen. In block 2602, the operator inserts the specimen into the hematology analyzer. In block 2603, the PSRIS (for example, PSRIS 2505 in FIG. 25) illuminates the inserted specimen. In block 2604, an image is then generated. In block 2605, the generated image is inspected for validity (i.e. whether it can be processed by the system) and if invalid, the logic continues in block 2601 to collect another specimen. If instead in block 2605 the image is valid for processing, then in block 2606, it is analyzed and in block 2607 the diagnostic results are returned.

All of the above U.S. patents, U.S. patent application publications, U.S. patent applications, foreign patents, foreign patent applications and non-patent publications referred to in this specification and/or listed in the Application Data Sheet, including but not limited to U.S. Provisional Patent Application No. 63/706,852, entitled “METHOD, TECHNIQUES, AND SYSTEM FOR PROLATE SPHEROID RING ILLUMINATION SYSTEM,” filed Oct. 14, 2024, are incorporated herein by reference, in their entireties.

From the foregoing it will be appreciated that, although specific embodiments have been described herein for purposes of illustration, various modifications may be made without deviating from the spirit and scope of the invention. For example, the methods and systems for constructing a Prolate Spheroid Ring Illumination assembly discussed herein are applicable to other uses other than microscopes and point of care devices. In addition, different sources of illumination such as fiber optics and other forms of electromagnetic impulses can be incorporated without deviating from the spirit and scope of this disclosure.

1. A configurable solid state optical illumination system, comprising:
one or more illumination sources;
an assembly of one or more reflector segments, each reflector segment having a first reflection surface shaped to reflect and concentrate light from a respective illumination source of the one or more illumination sources along at least one respective optical ray path from the respective illumination source to a respective illumination area of one or more illumination areas, thereby providing concentrated oblique illumination to the one or more illumination areas; and
a housing that surrounds the reflector segment assembly and includes a through aperture that allows light that is scattered, reflected, or otherwise emitted from a sample placed in the one or more illumination areas to pass unobstructed through the configurable solid state optical illumination system, wherein the housing is operable in one of two orientations when resting on a flat surface.

2. The illumination system of claim 1 wherein the orientations include a transmission lighting mode and a reflection lighting mode.

3. The illumination system of claim 2 wherein the housing is configured to be flipped 180 degrees to operate in each of the two orientations.

4. The illumination system of claim 1 wherein the one or more illumination sources include one or more LEDs.

5. The illumination system of claim 1 wherein the one or more illumination sources include a plurality of LEDs and at least two of the plurality of LEDs have different wavelengths.

6. The illumination system of claim 1 wherein the one or more illumination sources include an exit aperture of one or more optical fiber sources.

7. The illumination system of claim 1 wherein an area of concentrated oblique illumination is coincident with a top surface of a microscope slide when the illumination system and the slide are resting on a same flat surface.

8. The illumination system of claim 1 wherein an area of concentrated oblique illumination is coincident with the top surface of a microscope slide after passing through the slide when the slide is resting on the housing of the illumination system.

9. The illumination system of claim 1 wherein the illumination system provides concentrated oblique illumination to a sample and is usable with a variety of existing microscopes or existing imaging systems.

10. The illumination system of claim 1 wherein the assembly is configured to provide concentrated oblique illumination to the one or more illumination areas without the use of an auxiliary lens element, a flat mirror, or a ring of diffusing material to direct and concentrate light from the one or more light sources.

11. The illumination system of claim 1 wherein the curvature of the first reflection surface of at least one of the one or more reflector segments is substantially a section of a prolate spheroid.

12. The illumination system of claim 1 wherein the assembly comprises six reflector segments and wherein, for each reflector segment, the curvature of the first reflection surface is substantially a section of a respective prolate spheroid and the respective illumination source is centered at a first focus point of the respective prolate spheroid and the respective illumination area is centered at a second focus point of the respective prolate spheroid.

13. The illumination system of claim 1 wherein the assembly further comprises one or more auxiliary reflective surfaces and wherein the assembly is configured such that, for at least one of the one or more reflector segments, the at least one respective optical ray path from the respective illumination source to the respective illumination area causes light to propagate from the respective illumination source to the one or more auxiliary reflective surfaces, to the first reflection surface, and to the respective illumination area.

14. The illumination system of claim 13 wherein the curvature of the first reflection surface of at least one of the one or more reflector segments is substantially a section of a prolate spheroid, and wherein the assembly is configured such that, for the at least one reflector segment of the one or more reflector segments, a one of the one or more auxiliary reflection surfaces is located halfway between the first focus point of the section of the prolate spheroid of the at least one reflector segment and a respective illumination source and is oriented perpendicular to an imaginary axis between the first focus point of the section of the prolate spheroid and the respective illumination source.

15. The illumination system of claim 13 wherein the assembly is configured such that, for at least one reflector segment of the one or more reflector segments, the at least one respective optical ray path from the respective illumination source causes light to propagate from the respective illumination source to the one or more auxiliary reflective surfaces, to the first reflection surface, and to the respective illumination area, creating at least three folds in the at least one respective optical ray path prior to providing illumination to the illumination area.

16. The illumination system of claim 13 wherein the assembly is configured such that an operational thickness of the illumination system is reduced by, for each of the one or more reflector segments, increasing the number of folds of each of the at least one respective optical ray path from the respective illumination source to the one or more auxiliary reflective surfaces, to the first reflective surface, and to the respective illumination area.

17. The illumination system of claim 1 wherein the operational thickness of the system is less than 1 cm.

18. The illumination system of claim 1 wherein the illumination system is used with an objective lens of a microscope or imaging system and wherein the operational thickness of the system is less than a working distance of the objective lens.

19. The illumination system of claim 1 wherein the illumination system is used with an objective lens of a microscope or imaging system and the housing rests on a flat surface without attachment by mounting hardware to the microscope or imaging system.

20. The illumination system of claim 1 wherein the assembly provides a substantially uniform angular ring of incident radiance around a central axis, thereby providing substantially uniform oblique illumination to the one or more illumination areas.

21. The illumination system of claim 1 wherein the power incident on the one or more illumination areas originates from a bounded range of elevation angles, thereby providing substantially uniform oblique illumination to the one or more illumination areas.

22. The illumination system of claim 1, further configured to provide dark-field reflected light illumination or dark-field transmitted light illumination to a sample for inspection by a microscope or an imaging system.

23. The illumination system of claim 1, further comprising a baffle configured to prevent non-reflected rays from exiting the illumination system, to prevent non-reflected rays from entering an adjacent or non-adjacent reflector segment, and/or to prevent some reflected rays from reaching the illumination area.

24. The illumination system of claim 1, the one or more illumination sources comprising a plurality of illumination sources, wherein at least two of the plurality of illumination sources are configured to emit different wavelengths of light and/or wherein at least two of the plurality of illumination sources are configured to illuminate the sample from distinct ranges of angles, and wherein the system is configured to minimize a time required to switch between illumination wavelengths and/or illumination angles.

25. The illumination system of claim 1 wherein the housing and the assembly of the one or more reflector segments are fabricated as an integrated unit.

26. A configurable solid state optical illumination system usable with an existing microscope or existing electronic imaging system, comprising:
a plurality of light sources surrounding a first central aperture;
an assembly of a plurality of reflector segments surrounding a second central aperture, each reflector segment having a reflection surface and configured to reflect and concentrate light from a respective light source of the plurality of light sources along at least one respective optical ray path from the respective light source to the reflection surface and then to a respective illumination area; and
a housing having a third central aperture that surrounds the reflector segment assembly and the plurality of light sources surrounding the first central aperture and including a through aperture formed from the first, second, and third apertures that allows light that is scattered, reflected, or otherwise emitted from a sample placed in the illumination area to pass unobstructed through the configurable solid state optical illumination system, wherein operational thickness of the system is less than an objective lens working distance of the existing microscope or the existing electronic imaging system.

27. The optical illumination system of claim 26 wherein the housing is operable in one of two orientations when resting on a flat surface, the orientations including a transmission lighting mode and a reflection lighting mode.

28. The illumination system of claim 26 wherein the plurality of light sources include one or more LEDs mounted on a printed circuit board and surrounded by the housing.

29. The illumination system of claim 26 wherein at least one of the LEDs has a wavelength corresponding to UV light with a wavelength of 400 nm or less.

30. The illumination system of claim 26 wherein the operational thickness of the system is less than 1 cm.
